(19) United States
(12) Patent Application Publication
(10) Pub. No.: US 2025/0093791 A1
(43) Pub. Date: Mar. 20, 2025

(54) TONER

(71) Applicant: CANON KABUSHIKI KAISHA, Tokyo (JP)

(72) Inventors: KOKI INOUE, Shizuoka (JP); YOSHIAKI SHIOTARI, Shizuoka (JP); KOZUE URATANI, Shizuoka (JP)

(21) Appl. No.: 18/885,366

(22) Filed: Sep. 13, 2024

(30) Foreign Application Priority Data
Sep. 19, 2023 (JP) 2023-151473
Sep. 2, 2024 (JP) 2024-150913

(51) Int. Cl. G03G 9/093

(52) U.S. Cl. CPC G03G 9/09328; G03G 9/09378

(57) ABSTRACT

A toner comprising a toner particle comprising a binder resin, wherein the toner particle comprises a toner base particle and a silicon polymer composite present at a surface of the toner base particle, the silicon polymer composite comprises a silicon polymer and a specific metal atom, and when, in X-ray photoelectron spectroscopy on the toner, a ratio of the number of the specific metal atom is defined as ME and a ratio of the number of the silicon atom is defined as SiE, and when, in an EDS mapping image of constituent elements in a cross section of the toner, a ratio of the number of the specific metal atom to a sum of the number of the silicon atom and the specific metal atom in a region outside a contour of the toner base particle is defined as MX, ME, SiE, and MX satisfy a specific relationship.

### BACKGROUND OF THE INVENTION

### Field of the Invention

The present disclosure relates to a toner used in an electrophotographic system.

### Description of the Related Art

In recent years, the range of fields where electrophotographic image formation is used has become wide, ranging from printers and copiers to commercial printing machines. Along with this, there is an increasing demand for high image quality, speeding up, and high durability required for electrophotography. In addition, with the improvement in performance of electrophotography, the electrophotography has become widespread worldwide, and is used in various environments both indoors and outdoors. It is required to always provide a high-quality image while coping with such various environments.

With the speeding up described above, the contact time between a toner and a charging member tends to be shortened. Therefore, the time for providing a charge to the toner is shortened, and the problem of occurrence of fogging which will be described below becomes more pronounced.

First, a fogging occurrence process will be described. After being conveyed onto a toner carrying member, the toner is triboelectrically charged by being rubbed with a charge-providing member. Thereafter, the toner flies from the toner carrying member to an electrostatic latent image on an electrostatic latent image bearing member (hereinafter, an electrophotographic photosensitive member or a photosensitive member) by electrostatic force, whereby an image is formed. In a case where a toner is not triboelectrically charged sufficiently and uniformly, there is a large amount of toner having a low charge amount or toner in which an absolute value of charge is inverted, and a charge distribution is prone to be broad. As a result, this toner flies to a non-image portion, and an image defect (hereinafter, referred to as fogging) in which a non-printing portion is colored occurs.

In a case where the printing process described above is speeded up, charging abnormalities such as generation of toner having a low charge amount or generation of toner in which an absolute value of the charge is inverted is prone to occur, and fogging is prone to occur.

For the purpose of ameliorating such fogging, studies have been made to promote electrostatic induction and dielectric polarization in an injection charging process in addition to triboelectric charging in a conventional triboelectric charging process and to improve charge rising performance by allowing conductive fine particles to be present on a toner surface. Here, the injection charging process is a process of charging a toner by injecting charges by a potential difference between the toner and a charging member. In these processes, by allowing conductive fine particles to be present on a toner surface, it is possible to increase the number of charged sites on the toner surface. Therefore, even in a case where the charge providing time is shortened due to speeding up, sufficient charging can be provided to a toner, so that occurrence of fogging can be suppressed in a normal temperature and normal humidity environment.

However, under a high temperature and high humidity environment, it is difficult to obtain an effect of suppressing fogging by adding the conductive fine particles to a surface. This is because, since the conductive fine particles act as a moisture adsorption site, when the number of conductive fine particles on the toner surface is increased in order to cope with speeding up, moisture is prone to be adsorbed on the toner surface accordingly. This influence is particularly pronounced when an image forming apparatus is activated after toner is left for a long time in an environment having a high absolute moisture amount.

For these problems, Japanese Patent Application Publication No. 2011-118210 discloses a toner in which fogging is suppressed by improving charge stability, in a manner that a silica titania composite particle having a core-shell structure, in which a content of silica and a zeta potential are controlled is produced by a gas phase method and is externally added to a toner particle surface.

Japanese Patent Application Publication No. 2007-017486 discloses a toner capable of imparting stable charging characteristics through an image durability test and suppressing fogging by introducing weakly negative aluminum (alumina) or titanium into —Si—Si-bonding of a silica particle known as a strong negative material as an external additive of a toner.

Japanese Patent Application Publication No. 2021-021791 discloses a toner in which a protrusion formed of an organosilicon polymer is present on a toner particle surface and a polyhydric acid metal salt is present on a surface of the protrusion to realize an injection charging process and suppress a change in charge amount due to an environment. When using the injection charging process, it is possible to uniformly and quickly charge not only a portion in contact with a charging member but also the entire toner by causing a conductive path to be present in a toner or between toners. Therefore, even when the amount of polyhydric acid metal salt present on a surface is small, the favorable rise-up of charging can be achieved. In addition, according to the injection charging, since the charge amount can be controlled as desired by changing a potential difference, it is hardly affected by humidity. Therefore, it is possible to suppress a change in the charge amount due to an environment and to suppress fogging.

### SUMMARY OF THE INVENTION

In the toner described in Japanese Patent Application Publication No. 2011-118210, since the toner has a core-shell structure in which titania is covered with silica, a zeta potential is controlled, the maintenance and rise-up of charging are improved, and fogging is suppressed. However, in the toner described in Japanese Patent Application Publication No. 2011-118210, since an addition amount of titania is large, an excessive conductive path is prone to be generated, and it is difficult to completely control the core-shell structure in a composite oxide prepared by a gas phase method. Therefore, charges may leak through the partially exposed titania, and the charge rising performance may be deteriorated.

The toner described in Japanese Patent Application Publication No. 2007-017486 achieves charge stability by doping silica particles with a small amount of titanium, without increasing the number of moisture adsorption sites. However, in a composite oxide generated by vapor phase oxidation of a metal halide compound, the presence position of titanium cannot be controlled, and the amount of titanium exposed on a toner surface is extremely large. Therefore, the problem of fogging due to adsorption of moisture by titanium on a surface under high temperature and high humidity remains. In addition, in the toner described in Japanese Patent Application Publication No. 2007-017486, since only a very small amount of titanium is contained and the dispersed state is not controlled, there are not a sufficient number of charging sites for triboelectric charging, and a sufficient charge amount cannot be obtained. Therefore, this method is insufficient for eliminating fogging in the speeded-up printing process required in recent years.

The toner described in Japanese Patent Application Publication No. 2021-021791 achieves charge rising performance that has hardly any dependence on an environment by using an injection charging process. On the other hand, since metal atoms derived from a polyhydric acid metal salt are unevenly distributed on the outermost surface of a toner, there are many moisture adsorption sites, and the exposed polyhydric acid metal salt acts as a charge leakage point. Therefore, charge leakage suppression is not sufficient to cope with speeding up the process under high temperature and high humidity, and particularly, sufficient charging performance may not be obtained for fogging suppression under severe high temperature and high humidity.

Therefore, the present disclosure provides a toner that enables precise charge control and can achieve elimination of fogging independent of an environment including a severe high temperature and high humidity environment even in speeding up a printing process.

The present disclosure relates to a toner comprising a toner particle comprising a binder resin,
wherein the toner particle comprises a toner base particle and a silicon polymer composite present at a surface of the toner base particle,
the silicon polymer composite comprises
   a silicon polymer and
   at least one specific metal atom selected from the group consisting of metal atoms included in Groups 3 to 13, and
when, a ratio of the number of the specific metal atom to a sum of the numbers of a carbon atom, an oxygen atom, a silicon atom, a phosphorus atom, and the specific metal atom obtained by X-ray photoelectron spectroscopy on the toner is defined as ME, and a ratio of the number of the silicon atom to a sum of the numbers of a carbon atom, an oxygen atom, a silicon atom, a phosphorus atom, and the specific metal atom obtained by X-ray photoelectron spectroscopy on the toner is defined as SiE, and
in an EDS mapping image of constituent elements in a cross section of the toner obtained by analyzing with use of energy dispersive X-ray spectroscopy, the cross section of the toner observed with a transmission electron microscope, a ratio of the number of the specific metal atom to a sum of the numbers of a silicon atom and the specific metal atom in a region outside a contour of the toner base particle is defined as MX,
the ME, the SiE, and the MX satisfy Formulae (1) and (2) below:

$$0.5 \leq ( ME / Si E ) / MX \leq 2.5 ; and \qquad ( 1 )$$

$$5. \times {10}^{- 3} \leq MX \leq 6. \times {10}^{- 2} . \qquad ( 2 )$$

According to the present disclosure, it is possible to provide a toner that enables precise charge control by achieving both a high level of rise-up of charging and charge leakage suppression associated with moisture adsorption, and capable of achieving elimination of fogging independent of an environment including a severe high temperature and high humidity environment even in speeding up a printing process. Further features of the present invention will become apparent from the following description of exemplary embodiments with reference to the attached drawings.

### BRIEF DESCRIPTION OF THE DRAWINGS

FIG. 1 is an example of a STEM image diagram of a toner used in the present Example; and

FIG. 2 is a schematic diagram of a toner cross section used in the present Example.

### DESCRIPTION OF THE EMBODIMENTS

In the present disclosure, “from XX to YY” or “XX to YY” indicating a numerical range means a numerical range including a lower limit and an upper limit that are end points unless otherwise specified. In a case where numerical ranges are described in stages, an upper limit and a lower limit of each numerical range can be combined as desired. Furthermore, in the present disclosure, for example, description such as “at least one selected from the group consisting of XX, YY, and ZZ” means any of XX, YY, ZZ, a combination of XX and YY, a combination of XX and ZZ, a combination of YY and ZZ, or a combination of XX, YY, and ZZ. When XX is a group, a plurality of constituents may be selected from XX, and the same applies to YY and ZZ.

In a toner charging process in triboelectric charging, in a case where the printing process is speeded up, rubbing between a charging member or a carrier (hereinafter, collectively referred to as a charging member) and a toner is not sufficient, and there is a large amount of toner having a low charge amount or toner in which an absolute value of charge is inverted, and a distribution of charge of a toner may become broad. In particular, this influence is pronounced after being left for a long period of time in a high temperature and high humidity environment. In order to suppress generation of a toner having a low charge amount or a toner in which an absolute value of charge is inverted independently of an environment, it is effective to control a charge amount to be a predetermined charge amount by injecting charges from the charging member into a toner.

In this case, in a case where injection charging is performed while a polyhydric acid metal salt as described in Japanese Patent Application Publication No. 2021-021791 is unevenly distributed on an outermost surface of a toner, charges may leak through an exposed polyhydric acid metal salt. Furthermore, charges may leak due to moisture adsorbed to the polyhydric acid metal salt on a surface, and sufficient charge rising performance for eliminating fogging may not be obtained. Therefore, in order to enhance the charge rising performance in speeding up the printing process under a high temperature and high humidity environment, it is necessary to enhance charge retention by suppressing charge leakage via a polyhydric acid metal salt or adsorbed moisture while enhancing charge injection performance.

As a result of intensive studies, the present inventors have found that a toner having the following configuration can achieve the elimination of fogging even when a printing process is speeded up under any environment including a severe high temperature and high humidity environment.

That is, the present disclosure relates to a toner comprising a toner particle comprising a binder resin,
wherein the toner particle comprises a toner base particle and a silicon polymer composite present at a surface of the toner base particle,
the silicon polymer composite comprises
   a silicon polymer and
   at least one specific metal atom selected from the group consisting of metal atoms included in Groups 3 to 13, and
when, a ratio of the number of the specific metal atom to a sum of the numbers of a carbon atom, an oxygen atom, a silicon atom, a phosphorus atom, and the specific metal atom obtained by X-ray photoelectron spectroscopy on the toner is defined as ME, and a ratio of the number of the silicon atom to a sum of the numbers of a carbon atom, an oxygen atom, a silicon atom, a phosphorus atom, and the specific metal atom obtained by X-ray photoelectron spectroscopy on the toner is defined as SiE, and
in an EDS mapping image of constituent elements in a cross section of the toner obtained by analyzing with use of energy dispersive X-ray spectroscopy, the cross section of the toner observed with a transmission electron microscope, a ratio of the number of the specific metal atom to a sum of the numbers of a silicon atom and the specific metal atom in a region outside a contour of the toner base particle is defined as MX,
ME, SiE, and MX satisfy Formulae (1) and (2) below:

$$0.5 \leq ( ME / Si E ) / MX \leq 2.5 ; and \qquad ( 1 )$$

$$5. \times {10}^{- 3} \leq MX \leq 6. \times {10}^{- 2} . \qquad ( 2 )$$

The present inventors considered that the above problems could be solved if the exposure of metal atoms and the moisture adsorption to conductive fine particles can be suppressed even in a case where metal atoms are present in the vicinity of a toner surface for improving the charge rising performance. Furthermore, the present inventors have considered that it is effective to coat metal atoms with a material which is highly insulating such as a silicon polymer in order to simultaneously suppress moisture adsorption and charge leakage.

Specifically, the present inventors have considered that it is necessary to control a surface exposure ratio and an absolute amount of metal atoms in addition to forming a composite of metal atoms and a silicon polymer.

The present inventors consider the mechanism of expressing an effect of the present disclosure as follows.

First, a toner of the present disclosure is characterized in that a silicon polymer and at least one specific metal atom selected from the group consisting of metal atoms included in Groups 3 to 13 forms a silicon polymer composite. In a case where such a configuration is adopted, a metal atom is covered with the silicon polymer, and moisture adsorption to the metal atom is suppressed, so that occurrence of fogging in a high temperature and high humidity environment can be suppressed.

In addition, since the silicon polymer and the metal are combined, a dielectric polarization of the silicon polymer, which is an adjacent dielectric, is promoted along with the electrostatic induction of the metal, as compared with a case where a metal atom-containing particle and a silicon polymer particle are each independently present. Accordingly, it is considered that sufficient charge rising performance can be exhibited even in a case where the surface exposure ratio or the absolute amount of metal atoms is small.

The silicon polymer composite in the present disclosure has a configuration in which a silicon polymer and a compound containing the above-described specific metal atom are present adjacent to each other.

In particular, a compound formed of metal atoms included in Groups 3 to 13 has lower water absorbability than that of a compound containing only metal atoms included in Groups 1 and 2, and therefore has higher charge stability in a high temperature and high humidity environment. Furthermore, since the metal atoms included in Groups 3 to 13 have a valence of 2 or more and form a crosslinked structure with an oxygen atom of a silicon polymer, a strong silicon polymer composite can be formed. Therefore, high charge stability can be maintained through a long-term durability test.

In addition, since the silicon polymer contained in the silicon polymer composite has a skeleton of a siloxane bond in a molecule, an oxygen atom segment having high electronegativity exhibits high affinity with a metal atom. Since the silicon polymer has affinity with a specific metal atom, the specific metal atom can be present by being highly dispersed in the silicon polymer composite without forming a large aggregate. Therefore, it is considered that a percolation phenomenon is prone to occur, and even when a content of metal atoms is small, charge transfer occurs between metal atoms, so that a large electric dipole can be formed. As a result, the charge injection performance is high, the rise-up of charging is favorable, and the elimination of fogging can be achieved.

As described above, the toner of the present disclosure is characterized in that a specific metal atom forms a composite with a silicon polymer, and in addition, a presence position and a presence amount of the specific metal atom are highly controlled.

In the present disclosure, a value of a ratio of a metal amount (ME/SiE) of an outermost surface measured by X-ray photoelectron spectroscopy (ESCA) to a presence amount MX of a specific metal atom measured by observation of a toner cross section with a scanning transmission electron microscope (STEM) is used as an index indicating a presence position of the specific metal atom. MX reflects a total specific metal atom amount in the vicinity of the surface of the toner, and (ME/SiE) reflects a specific metal atom amount existing at a depth of several nm from the toner surface.

That is, a ratio of the number of the specific metal atom to a sum of the numbers of a carbon atom, an oxygen atom, a silicon atom, a phosphorus atom, and the specific metal atom obtained based on an X-ray photoelectron spectroscopy using a toner as a sample is defined as ME, and a ratio of the number of the silicon atom to a sum of the numbers of a carbon atom, an oxygen atom, a silicon atom, a phosphorus atom, and the specific metal atom obtained based on an X-ray photoelectron spectroscopy using a toner as a sample is defined as SiE.

In addition, an EDS mapping image of constituent elements in a cross section of the toner is obtained by analyzing with use of energy dispersive X-ray spectroscopy, the cross section of the toner observed with a transmission electron microscope. In the EDS mapping image, a ratio of the number of the specific metal atom to the sum of the numbers of a silicon atom and the specific metal atom in a region outside the contour of a toner base particle is defined as MX.

In this case, ME, SiE, and MX satisfy Formulae (1) and (2) below.

$$0.5 \leq ( ME / Si E ) / MX \leq 2.5 \qquad ( 1 )$$

$$5. \times {10}^{- 3} \leq MX \leq 6. \times {10}^{- 2} \qquad ( 2 )$$

In the above formula (1), the value of the ratio of (ME/SiE) to MX represents a ratio of the specific metal atom exposed on a surface, and the larger the value, the larger the surface exposure ratio of the specific metal atom. In the above formula (1), the fact that the ratio of (ME/SiE) to MX is 0.50 or more indicates a state in which a very small amount of specific metal atoms are exposed on the surface of the silicon polymer composite, and it is possible to suppress excessive charge from staying in the silicon polymer composite and overcharge from occurring. As a result, it is possible to suppress the occurrence of fogging caused by overcharging which is remarkably exhibited particularly in a low temperature and low humidity environment.

When the ratio of (ME/SiE) to MX is 2.50 or less, the amount of specific metal atoms exposed on the surface of the silicon polymer composite can be reduced. As a result, leakage of charges through exposed specific metal atoms and moisture adsorbed to the specific metal atoms can be suppressed, and therefore occurrence of fogging in a high temperature and high humidity environment can be suppressed.

Furthermore, in a case where the above formula (1) is satisfied, it is considered that a configuration in which most of the specific metal atoms are encapsulated in a silicon polymer which is a dielectric is adopted. In this case, when the specific metal atom is electrostatically polarized by applying a bias to the toner charging member, polarization of the dielectric adjacent to the specific metal atom is promoted. This effect is particularly pronounced particularly in a case of a material that is likely to undergo dielectric polarization such as a silicon polymer.

Furthermore, encapsulating most of the specific metal atoms with a silicon polymer so as to satisfy the above formula (1) is also effective for enhancing dispersibility of the specific metal atoms. In this case, it is considered that particles of specific metal atoms are present with favorable dispersibility in a matrix of the silicon polymer. Therefore, at a certain particle filling rate, a conductive path is formed by connecting particles, and a so-called percolation phenomenon in which conductivity rapidly increases is developed. Therefore, the toner of the present disclosure can form a large electric dipole by generating a favorable conductive path between metal atoms even when the content of the specific metal atom is small.

According to the above mechanism, it is considered that the charge injection performance is enhanced, favorable rise-up of charging are exhibited, and the elimination of fogging can be achieved regardless of the environment including a severe high temperature and high humidity environment.

The ratio value (ME/SiE)/MX is preferably 0.65 to 2.10, and more preferably 0.75 to 1.90.

Furthermore, in the toner of the present disclosure, it is necessary to control the absolute amount of the specific metal atom using MX as an index in addition to the exposure ratio of the specific metal atom on the surface as described above. That is, it is necessary to satisfy the above formula (2).

In the above formula (2), when MX is 5.0×10⁻³ or more, the charge injection performance by the charging member is improved. Therefore, high charge rising performance can be exhibited, and occurrence of fogging in a high temperature and high humidity environment can be suppressed. When MX is 6.0×10⁻² or less, the absolute amount of the specific metal atoms exposed on the surface of the silicon polymer composite can be reduced. Therefore, it is considered that leakage of charges through exposed metal atoms and moisture adsorbed to the metal atoms can be suppressed, and occurrence of fogging in a high temperature and high humidity environment can be suppressed.

To summarize the above mechanism, it is considered that a small amount of specific metal atoms in the vicinity of the toner surface are encapsulated in a specific range in the silicon polymer, so that moisture adsorption or charge leakage via the metal atoms can be suppressed. Furthermore, it is considered that high charge injection performance can be achieved by dispersing metal atoms in a silicon polymer having a high polarizability among insulators. In this manner, it is considered that both effects of leakage suppression and the rise-up of charging are obtained.

In addition, the present disclosure realizes, for the first time, a configuration in which not only a small amount of a specific metal atom and a silicon polymer are present on the toner surface as a composite, but also the presence position and a presence amount of the specific metal atom are highly controlled. With this feature, fogging suppression can be achieved even if the printing process is speeded up in any environment, including a severe high temperature and high humidity environment.

Examples of a method for obtaining the toner satisfying the above formulae (1) and (2) include a method in which a metal compound serving as a metal source and a silicon compound are reacted in an aqueous medium in which toner base particles are dispersed to obtain a silicon polymer composite, and a method in which a silicon polymer composite is attached onto a toner particle by a mechanical external force in a dry or wet manner. A detailed method will be described later.

In addition to the above configuration, the toner will be described below.

### State of Surface of Toner Particle

The specific metal atom may be at least one metal element selected from the group consisting of metal elements included in Groups 3 to 13. Specific examples of the specific metal atom include at least one selected from the group consisting of titanium (Group 4, electronegativity: 1.54), zirconium (Group 4, electronegativity: 1.33), aluminum (Group 13, electronegativity: 1.61), zinc (Group 12, electronegativity: 1.65), indium (Group 13, electronegativity: 1.78), hafnium (Group 4, electronegativity: 1.30), iron (Group 8, electronegativity: 1.83), copper (Group 11, electronegativity: 1.90), and silver (Group 11, electronegativity: 1.93).

The specific metal atom is preferably at least one metal atom selected from the group consisting of titanium, zirconium, copper, and aluminum.

The method for obtaining the above-described silicon polymer composite is not particularly limited. Examples thereof include a method for obtaining a silicon polymer composite by reacting a metal compound serving as a metal source with a silicon compound in an aqueous medium, and a method for obtaining a silicon polymer composite by growing a silicon polymer and a metal salt so as to share an interface. Among these, a method for obtaining a silicon polymer composite by reacting a metal compound serving as a metal source with a silicon compound in an aqueous medium is preferable.

The silicon polymer composite is preferably a reaction product of a metal compound and a silicon compound. As a metal source in the case of obtaining the silicon polymer composite, a known metal compound can be used without particular limitation as long as it is a metal compound that reacts with an acid to provide a metal salt or a metal compound that reacts with a silicon compound to provide a silicon polymer composite.

Among these, the metal compound is preferably a metal chelate because the reaction is easily controlled and the metal chelate quantitatively reacts with an acid or a silicon compound. Further, from the viewpoint of solubility in an aqueous medium, a lactic acid chelate such as titanium lactate and zirconium lactate is more preferable.

Specific examples of the metal compound serving as a metal source include at least one selected from the group consisting of metal chelates such as titanium lactate, titanium tetraacetylacetonate, titanium lactate ammonium salt, titanium triethanolaminate, zirconium lactate, zirconium lactate ammonium salt, aluminum lactate, aluminum trisacetylacetonate, and copper lactate, and metal alkoxides such as titanium tetraisopropoxide, titanium ethoxide, zirconium tetraisopropoxide, and aluminum triisopropoxide.

The metal compound is preferably at least one selected from the group consisting of metal chelates, and more preferably at least one lactic acid chelate selected from the group consisting of titanium lactate, titanium lactate ammonium salt, zirconium lactate, zirconium lactate ammonium salt, aluminum lactate, and copper lactate.

As the silicon polymer, a known silicon polymer can be used without particular limitation. Among these, the silicon polymer is preferably an organosilicon polymer having a structure (T3 unit structure) represented by the following formula (5). The silicon polymer composite is preferably an organosilicon polymer composite.

R—SiO_{3/2} (5)

(In the formula (5), R represents an alkyl group having 1 to 6 (preferably 1 to 3, more preferably 1 or 2, and further preferably 1) carbon atoms, an alkenyl group (having preferably 1 to 6, and more preferably 1 to 4 carbon atoms), an acyl group (having preferably 1 to 6, and more preferably 1 to 4 carbon atoms), an aryl group (having preferably 6 to 14, and more preferably 6 to 10 carbon atoms), or a methacryloxyalkyl group.)

The above formula (5) represents that the organosilicon polymer has an organic group and a silicon polymer part. As a result, in the organosilicon polymer having the structure represented by the above formula (5), the organic group has affinity with a toner base particle, so that the organosilicon polymer is firmly fixed to the toner base particle, and the silicon polymer part has affinity with the specific metal atom, so that a strong composite is formed. As described above, since the silicon polymer composite has a structure firmly fixed to the toner base particle on a toner surface, higher charge stability can be maintained through a long-term durability test.

Furthermore, since the silicon polymer is an organosilicon polymer, the electrical resistance of the silicon polymer with which the specific metal atom is coated increases. As a result, it is possible to prevent charges from leaking from the toner to the toner contact member via the silicon polymer, and to further suppress fogging.

On the other hand, since the organosilicon polymer has a high dielectric constant, the organosilicon polymer is induced by electrostatic polarization of a specific metal atom, and exhibits high dielectric polarization performance. Therefore, a high charge rising performance can be exhibited even in a high temperature and high humidity environment, and the occurrence of fogging can be further suppressed.

The content of the silicon compound is preferably from 0.3 parts by mass to 20.0 parts by mass with respect to 100.0 parts by mass of a binder resin or a polymerizable monomer, from the viewpoint of achieving both the expression of the above effect and the suppression of the decrease in fixing performance due to the high coating of the silicon polymer composite.

The silicon compound for obtaining the silicon polymer composite is not particularly limited. From the viewpoint of obtaining the structure represented by the formula (5), the silicon compound is preferably an organosilicon compound. As the organosilicon compound, a known organosilicon compound can be used without particular limitation. Among these, at least one organosilicon compound selected from the group consisting of organosilicon compounds represented by the following formula (6) is preferable.

R—Si—(Ra)₃ (6)

(In the formula (6), Ra each independently represent a halogen atom or an alkoxy group having 1 to 3 (preferably 1 or 2) carbon atoms, and R represents an alkyl group having 1 to 6 (preferably 1 to 3, more preferably 1 or 2, and further preferably 1) carbon atoms, an alkenyl group (having preferably 1 to 6, and more preferably 1 to 4 carbon atoms), an aryl group (having preferably 6 to 14, and more preferably 6 to 10 carbon atoms), an acyl group (having preferably 1 to 6, and more preferably 1 to 4 carbon atoms), or a methacryloxyalkyl group.)

Specific examples of a silane compound represented by the formula (6) include trifunctional silane compounds such as: trifunctional methylsilane compounds such as methyltrimethoxysilane, methyltriethoxysilane, methyldiethoxymethoxysilane, and methylethoxydimethoxysilane; trifunctional silane compounds such as ethyltrimethoxysilane, ethyltriethoxysilane, propyltrimethoxysilane, propyltriethoxysilane, butyltrimethoxysilane, butyltriethoxysilane, hexyltrimethoxysilane, and hexyltriethoxysilane; trifunctional phenylsilane compounds such as phenyltrimethoxysilane and phenyltriethoxysilane; trifunctional vinylsilane compounds such as vinyltrimethoxysilane and vinyltriethoxysilane; trifunctional allylsilane compounds such as allyltrimethoxysilane, allyltriethoxysilane, allyldiethoxymethoxysilane, and allylethoxydimethoxysilane; and trifunctional γ-methacryloxypropylsilane compounds such as γ-methacryloxypropyltrimethoxysilane, γ-methacryloxypropyltriethoxysilane, γ-methacryloxypropyldiethoxymethoxysilane, and γ-methacryloxypropylethoxydimethoxysilane.

MX preferably satisfies the formula (3) below.

$$1. \times {10}^{- 2} \leq MX \leq 6. \times {10}^{- 2} \qquad ( 3 )$$

In the above formula (3), when MX is 1.0×10⁻² or more, the charge injection performance by the charging member is further improved. Therefore, high charge rising performance can be exhibited, and the effect of suppressing fogging is further enhanced. Even in a case where MX, which is an index of the absolute amount of the specific metal atoms, is 1.0×10⁻² or more, most of specific metal atoms are encapsulated in the silicon polymer, so that the number of moisture adsorption sites on the toner surface is small and water absorbability is low. Therefore, aggregation between the toner and the toner can be suppressed, and a solid image followability in a high temperature and high humidity environment is further improved as the flowability is improved.

Here, the solid image followability is, in particular, density stability of the second and subsequent sheets at the time of continuous printing of an image (hereinafter, a solid image) having a very high overall print percentage (hereinafter, solid image followability). In order to stabilize the solid image followability, it is necessary to promptly supply a toner to a developing member such as a developing roller, and thus a toner is required to have high flowability.

MX is more preferably 1.1×10⁻²≤MX≤4.8×10⁻².

In the toner, the silicon polymer composite preferably fixes on the surface of the toner base particle in a protrusion shape. Since the silicon polymer composite has a protrusion shape, it is easy to encapsulate a specific metal atom, and leakage of charges through exposed metal atoms and moisture adsorbed to the metal atom can be suppressed, so that the effect of suppressing fogging in a high temperature and high humidity environment is further enhanced.

In addition, when the silicon polymer composite has a protrusion shape, a region where the specific metal atom can be present is widened, and thus the specific metal atom can be favorably dispersed in the silicon polymer composite. As a result, a conductive path is optimized and a rising performance is improved, so that the effect of suppressing fogging is further enhanced.

Furthermore, when the silicon polymer composite has a protrusion shape, a contact area between the toner and the member can be reduced as compared with the case where the silicon polymer has a film shape. As a result, leakage of charges through the silicon polymer composite can be suppressed, so that transferability is further improved. On the other hand, at the time of charge injection, uneven portions of the toner surface mesh with each other to form a scram structure between toners. In a case where such a structure is adopted, a favorable conductive path is formed between toners, so that the rising performance is further improved, and a larger fogging suppression effect can be obtained.

In order to fix the silicon polymer composite in a protrusion shape, for example, there is a method for controlling a condition for causing a condensation reaction of a silane coupling agent at a surface of a toner base particle in a state where the toner base particle is dispersed in an aqueous medium.

Further, an energy dispersive X-ray spectroscopy (EDS) mapping image of constituent elements on a cross section of a toner is obtained by analyzing the cross section of the toner observed with a transmission electron microscope with an EDS. In this EDS mapping image, as shown in the schematic diagram of FIG. 2, an image of a toner base particle 2 and an image of the silicon polymer composite 1 are observed, and the image of the silicon polymer composite 1 is preferably observed at a position corresponding to a surface of the toner base particle 2 in the image of the toner base particle 2.

When line scanning is performed in the EDS mapping image on a region X specified by a following method, a maximum value of a strength count of the specific metal atom is defined as Mmax, and an average value of the strength counts is defined as Mave, the Mmax and the Mave satisfy formula (4) below:

$$1. < M max / Mave < 1.8 \qquad ( 4 )$$

### Method for Specifying the Region X:

(i) End points of an interface formed by the image of the silicon polymer composite 1 and the image of the toner base particle 2 in the EDS mapping image are connected by a straight line to define a base line 3. Base line 3 is a line segment.

(ii) Among perpendicular lines connecting the base line and an outer surface of the image of the silicon polymer composite 1 (the surface opposite to a toner base particle side in the silicon polymer composite), a perpendicular line 5 having the maximum length is defined. The perpendicular line 5 is a perpendicular line L1. Here, the length of the perpendicular line 5 is an image height H (nm).

(iii) When a width of the image of the silicon polymer composite, which is a length of the base line, is defined as W, a line segment L2 connecting two points on an inner side of 0.1W from respective end portions of the base line is defined on the base line.

(iv) A region in which a line segment overlaps the image of the silicon polymer composite when the line segment L2 is moved to a position of a midpoint of the perpendicular line L1 in parallel with the base line in a direction in which the perpendicular line L1 extends is defined as “region X”.

The fact that the formula (4) is satisfied, that is, a value of a ratio of the maximum value Mmax of the strength counts to the average value Mave of the strength counts is smaller than 1.80 means that there are few portions where the specific metal atoms are extremely unevenly distributed in the silicon polymer composite. That is, it is considered that the specific metal atoms are highly dispersed in the silicon polymer composite. In this case, even when the amount of the specific metal atom in the toner is small, the above-described percolation phenomenon effectively works, so that higher injection charging performance can be exhibited. Therefore, even in a case where a structure in which metal atoms are coated with a silicon polymer composite in order to suppress moisture adsorption under a high temperature and high humidity environment is adopted, a sufficient charge amount can be obtained, and a larger fogging suppression effect can be obtained.

Mmax/Mave is more preferably 1.20 to 1.75, and still more preferably 1.20 to 1.60.

The conductivity of the silicon polymer composite measured at a frequency of 10 KHz is preferably 1.0×10⁻⁵ to 1.0×10⁻² S/m, and more preferably 1.0×10⁻⁴ to 1.0×10⁻² S/m.

When the conductivity measured at a frequency of 10 kHz is 1.0×10⁻⁵ S/m or more, charges are easily injected from a toner regulating member into a toner, injection charging performance is improved, and the effect of suppressing fogging is enhanced. In addition, when the conductivity measured at a frequency of 10 kHz is 1.0×10⁻2 S/m or less, leakage of charges to the toner carrying member due to excessive increase in conductivity can be suppressed, so that fogging is further improved with improvement in charge retention. Furthermore, since the charge retention is enhanced, the transferability is also further improved.

The conductivity of the silicon polymer composite can be calculated by sandwiching a powder of the silicon polymer composite between parallel plate electrodes and measuring a distance between the electrodes and a resistance value in a state where a constant load is applied using a torque driver. A detailed measurement method will be described later.

The conductivity of the silicon polymer composite measured at a frequency of 10 kHz can be controlled by a method for coating a surface of the silicon polymer composite with a polyhydric acid metal salt having a high conductivity or a method for increasing the resistance of the surface of the silicon polymer composite using a high-resistance silane coupling agent.

In the silicon polymer composite, it is preferable that at least parts of specific metal atoms and at least parts of silicon atoms are bonded via an oxygen atom. Here, the bond means a covalent bond. When the specific metal element is defined as M, the silicon polymer composite preferably has an M-O—Si bond. For example, in a case where the specific metal element is Ti, a Ti—O—Si bond is formed.

Since at least parts of the metal atoms and at least parts of the silicon atoms are bonded via an oxygen atom, the electrical interaction between the metal atoms and the silicon polymer increases, and the dielectric polarization of the silicon polymer induced by the electrostatic polarization of the metal atoms increases. Therefore, the effect of improving the rising performance by injection charging is greatly exhibited.

In addition, since at least parts of the metal atoms and at least parts of the silicon atoms are bonded to each other, it is possible to suppress the formation of agglomerates between the metal atoms, so that the dispersibility of the metal atoms in the silicon polymer composite is improved. Therefore, a conductive path is favorably formed, and high injection charging performance can be exhibited. As a result, a sufficient charge amount is obtained, and a larger fogging suppression effect can be obtained. The chemical bonding between the metal atom and the silicon atom via the oxygen atom is confirmed by a peak attributable to M-O—Si stretching vibration in a spectrum obtained by infrared spectroscopic analysis. Specifically, it will be described later.

The silicon polymer composite preferably contains a polyhydric acid metal salt containing a metal atom and a polyhydric acid. When the silicon polymer composite contains a polyhydric acid metal salt, the polyhydric acid metal salt functions as a charge injection site, and higher charge injection characteristics can be achieved. As a result, a sufficient charge amount is obtained, and a larger fogging suppression effect can be obtained.

The polyhydric acid is not particularly limited as long as it is a dihydric or higher acid.

A salt composed of a dihydric or higher acid and a metal atom forms a crosslinked structure between a compound containing a metal atom and a polyhydric acid, and the crosslinked structure promotes electron transfer and improves efficiency of injection charging.

Specific examples of the polyhydric acid include inorganic acids such as phosphoric acid (trihydric), carbonic acid (dihydric), and sulfuric acid (dihydric); organic acids such as dicarboxylic acid (dihydric) and tricarboxylic acid (trihydric). Specific examples of the organic acid include: the following dicarboxylic acids such as oxalic acid, malonic acid, succinic acid, glutaric acid, adipic acid, fumaric acid, maleic acid, pimelic acid, suberic acid, azelaic acid, sebacic acid, phthalic acid, isophthalic acid, and terephthalic acid; and at least one selected from the group consisting of tricarboxylic acids such as citric acid, aconitic acid, and trimellitic anhydride. Among them, at least one selected from the group consisting of phosphoric acid, carbonic acid, and sulfuric acid is preferable, and phosphoric acid is more preferable.

Specific examples of the polyhydric acid metal salt obtained by combining the metal and the polyhydric acid include at least one selected from the group consisting of: metal phosphates such as a titanium phosphate compound, a zirconium phosphate compound, an aluminum phosphate compound, and a copper phosphate compound; metal sulfate salts such as a titanium sulfate compound, a zirconium sulfate compound, and an aluminum sulfate compound; metal carbonates such as a titanium carbonate compound, a zirconium carbonate compound, and an aluminum carbonate compound; and metal oxalates such as a titanium oxalate compound. Among them, at least one selected from the group consisting of metal phosphates is preferable, and a titanium phosphate compound is more preferable, since the strength is high due to crosslinking between metals by phosphate ions.

The method for obtaining the polyhydric acid metal salt is not particularly limited, and a known method can be used. Among them, a method for obtaining a polyhydric acid metal salt by reacting a metal compound serving as a metal source with a polyhydric acid ion in an aqueous medium is preferable. That is, the polyhydric acid metal salt is preferably a reaction product of a metal compound and a polyhydric acid ion.

As the metal source in the case of obtaining the polyhydric acid metal salt by the above method, a known metal compound can be used without particular limitation as long as it is a metal compound that provides the polyhydric acid metal salt by reaction with a polyhydric acid ion.

Among them, a metal chelate is preferable because the reaction is easily controlled and the metal chelate quantitatively reacts with a polyhydric acid ion. Further, from the viewpoint of solubility in an aqueous medium, a lactic acid chelate such as titanium lactate and zirconium lactate is more preferable.

Specific examples of the metal source include at least one selected from the group consisting of: metal chelates such as titanium lactate, titanium tetraacetylacetonate, titanium lactate ammonium salt, titanium triethanolaminate, zirconium lactate, zirconium lactate ammonium salt, aluminum lactate, aluminum trisacetylacetonate, and copper lactate; and metal alkoxides such as titanium tetraisopropoxide, titanium ethoxide, zirconium tetraisopropoxide, and aluminum triisopropoxide.

As the polyhydric acid ion in the case of obtaining the polyhydric acid metal salt by the above method, the ion of the polyhydric acid described above can be used. As a form in a case of addition to an aqueous medium, a polyhydric acid itself may be added, or a water-soluble polyhydric acid metal salt may be added to an aqueous medium and dissociated in the aqueous medium.

The toner base particle preferably contains a condensation product of an organosilicon compound. The normalized strength of the silicon ion (m/z=28) derived from the condensation product and represented by the following formula (I) below, in the time-of-flight secondary ion mass spectrometry TOF-SIMS of the toner base particle is preferably 7.00×10⁻⁴ to 3.00×10⁻², and more preferably 1.00×10⁻³ to 1.00×10⁻².

$$Normalized strength of silicon ions ( m / z = 28 ) = \{ Ionic strength of silicon ions ( m / z = 28 ) \} / \{ Total ionic strength at m / z = 0.5 to 1850 \} \qquad ( I )$$

The normalized strength in the above range indicates that an extremely small amount of silicon ions are present on the surface of the toner base particle as compared with the prior art. Here, the surface of the toner base particle is obtained by removing the above-described silicon polymer composite. For example, the surface of the toner base particle is a surface of a toner base particle before the silicon polymer composite is applied to the toner base particle.

Examples of means for obtaining the normalized strength in the above range include means for using an extremely small amount of an organosilicon compound at the time of producing the toner base particle, controlling the hydrolysis of the organosilicon compound, or shortening the condensation time.

In a case where the normalized strength of the silicon ion (m/z=28) is 7.00×10⁻⁴ or more, charge injection performance is sufficiently exhibited, and excellent charging performance is obtained, so that the effect of suppressing fogging is further enhanced.

A mechanism for obtaining the above effect is considered as follows. It is considered that after the silicon polymer composite is charged in an injection charging process, charge is transferred to the condensation product of the organosilicon compound having a silyl group which is easily negatively charged on the surface of the toner base particle. Since the affinity between the silicon polymer composite and the condensation product of the organosilicon compound is extremely high, rapid charge transfer becomes possible. It is considered that since the transferred charge is retained on the surface of the toner base particle covered with the silicon polymer composite, charge leakage is small, and more stable charging characteristics can be exhibited.

Furthermore, since the condensation product of the organosilicon compound has an interaction with a binder resin, the silicon polymer composite and the binder resin can be firmly bound. Therefore, it is possible to more stably exhibit excellent charging characteristics even during long-term use.

Furthermore, in a case where the normalized strength of silicon ions (m/z=28) is 3.00×10⁻² or less, charge retention is further improved. A mechanism for obtaining the above effect is considered as follows.

In a case where a large amount of the condensation product of the organosilicon compound is present, a conductive path is formed on the entire surface of the toner base particle. As a result, charges also move to a portion of the toner surface not covered with the silicon polymer composite, and the portion may act as a charge leakage site. As described above, when the normalized strength of the silicon ion (m/z=28) is 3.00×10⁻² or less, only a very small amount of the condensation product of the organosilicon compound is present in the vicinity of the toner particle surface. Therefore, it is possible to suppress transfer of charges to a portion not covered with the silicon polymer composite, and charge retention is further improved. Accordingly, transferability is further improved.

In addition, the normalized strength of silicon ions (m/z=28) in the time-of-flight secondary ion mass spectrometry of the toner base particle sputtered by an Ar gas cluster ion beam Ar-GCIB under Conditions (A) below is preferably 6.99×10⁻⁴ or less.

### Condition (A)

Acceleration voltage: 5 kV, current: 6.5 nA, raster size: 600×600 μm, irradiation time: 5 sec/cycle, and sputtering time: 250 sec

By performing sputtering under the condition (A), silicon ions derived from the condensation product of the organosilicon compound present inside the toner base particle can be evaluated.

In a case where the amount of the condensation product of the organosilicon compound inside the toner particles is small, that is, the normalized strength of the silicon ion (m/z=28) satisfies the above range of 6.99×10⁻⁴ or less, transfer of charges to the entire toner can be suppressed, and thus charges are easily retained on the surface of the toner base particle covered with the silicon polymer composite. As a result, it is considered that the charge retention is further improved, and the transferability is further improved.

The normalized strength of silicon ions (m/z=28) after the sputtering is more preferably 1.00×10⁻⁵ to 6.99×10⁻⁴.

As a method for obtaining toner particles having a desired normalized strength of silicon ions (m/z=28), any method may be used.

For example, in a case where a condensation product of a silane coupling agent is used as the condensation product of the organosilicon compound, a method for appropriately adding a silane coupling agent and then performing condensation polymerization in a step of dissolving or dispersing a polymerizable monomer or a step of polymerizing a polymerizable monomer to obtain toner particles may be used. In addition, a method for adding a silane coupling agent to a dispersion of toner particles and performing condensation polymerization may be used. When controlling the timing of adding the polymerizable monomer, a presence position of silicon ions in the toner can be controlled.

Since the organosilicon compound may have an optimum pH for the condensation polymerization reaction, a reaction can be effectively advanced by condensation polymerization of the organosilicon compound at the optimum pH for the condensation polymerization reaction.

As a method for adding an organosilicon compound such as a silane coupling agent, the organosilicon compound may be added as it is, or may be added after being mixed with an aqueous medium and hydrolyzed in advance.

Examples of the method for controlling the normalized strength of silicon ions (m/z=28) in the vicinity of the toner particle surface or in the toner particle include a method for controlling the addition amount of an organosilicon compound for forming a condensation product of an organosilicon compound, a polymerization conversion of a polymerizable monomer, the hydrolysis time after addition of the organosilicon compound, the condensation polymerization time, or the like.

Examples of the condensation product of the organosilicon compound include a condensation product of an organosilicon compound such as a silane coupling agent, a silane-modified resin obtained by reacting a silane coupling agent, hydrosilane, or the like, a polymer of an organosilane compound, or a hybrid resin thereof, and a condensation product using these in combination. Among them, a condensation product of an organosilicon compound such as a silane coupling agent is preferable from the viewpoint of easily controlling the dispersibility in the toner base particles and the normalized strength of silicon ions (m/z=28).

As the silane coupling agent for forming the condensation product of the organosilicon compound, a known organosilicon compound can be used without particular limitation. Specific examples thereof include a bifunctional silane compound having two functional groups and a trifunctional silane compound having three functional groups as shown below.

Examples of the bifunctional silane compound include dimethyldimethoxysilane and dimethyldiethoxysilane.

Examples of the trifunctional silane compound include the following compounds.

A trifunctional silane compound having an alkyl group as a substituent, such as methyltrimethoxysilane, methyltriethoxysilane, methyldiethoxymethoxysilane, methylethoxydimethoxysilane, ethyltrimethoxysilane, ethyltriethoxysilane, propyltrimethoxysilane, propyltriethoxysilane, butyltrimethoxysilane, butyltriethoxysilane, hexyltrimethoxysilane, hexyltriethoxysilane, octyltrimethoxysilane, octyltriethoxysilane, decyltrimethoxysilane, and decyltriethoxysilane; a trifunctional silane compound having an alkenyl group as a substituent, such as vinyltrimethoxysilane, vinyltriethoxysilane, allyltrimethoxysilane, and allyltriethoxysilane; a trifunctional silane compound having an aryl group as a substituent, such as phenyltrimethoxysilane and phenyltriethoxysilane; a trifunctional silane compound having a methacryloxyalkyl group as a substituent, such as γ-methacryloxypropyltrimethoxysilane, γ-methacryloxypropyltriethoxysilane, γ-methacryloxyoctyltrimethoxysilane, γ-methacryloxypropyldiethoxymethoxysilane, γ-methacryloxypropylethoxydimethoxysilane, and 3-methacryloxypropyltris(trimethylsiloxy) silane; and a trifunctional silane compound having an acryloxyalkyl group as a substituent, such as γ-acryloxypropyltrimethoxysilane, γ-acryloxypropyltriethoxysilane, γ-acryloxyoctyltrimethoxysilane, γ-acryloxypropyldiethoxymethoxysilane, and γ-acryloxypropylethoxydimethoxysilane.

Hereinafter, materials that can be used for the toner other than the above-described materials will be described in detail.

### Binder Resin

The toner base particle contains a binder resin.

As the binder resin, a known resin can be used without any particular limitation. Specific examples thereof include vinyl-based resins, polyester resins, polyurethane resins, and polyamide resins. Examples of the polymerizable monomer (vinyl-based monomer) that can be used for producing the vinyl-based resin include styrene-based monomers such as styrene and α-methylstyrene; acrylic acid esters such as methyl acrylate and butyl acrylate; methacrylic acid esters such as methyl methacrylate, 2-hydroxyethyl methacrylate, t-butyl methacrylate, and 2-ethylhexyl methacrylate; unsaturated carboxylic acids such as acrylic acid and methacrylic acid; unsaturated dicarboxylic acids such as maleic acid; unsaturated dicarboxylic anhydrides such as maleic anhydride; nitrile-based vinyl monomers such as acrylonitrile; halogen-based vinyl monomers such as vinyl chloride; and nitro-based vinyl monomers such as nitrostyrene.

In order to reduce an environmental load, biomass-derived styrene and biomass-derived butyl acrylate can be used. The biomass-derived styrene and the biomass-derived butyl acrylate may be used alone or two kinds thereof may be used in combination.

Among them, a vinyl-based resin and a polyester resin are preferably contained as the binder resin.

### Colorant

The toner base particle may contain a colorant. As the colorant, conventionally known pigments and dyes of each color of black, yellow, magenta, and cyan, and other colors, magnetic bodies, and the like can be used without particular limitation.

Examples of the black colorant include black pigments such as carbon black.

Examples of the yellow colorant include yellow pigments and yellow dyes such as a monoazo compound; a disazo compound; a condensed azo compound; an isoindolinone compound; a benzimidazolone compound; an anthraquinone compound; an azo metal complex; a methine compound; and an allylamide compound.

Specific examples thereof include C.I. Pigment Yellow 74, 93, 95, 109, 111, 128, 155, 174, 180, and 185, and C.I. Solvent Yellow 162.

Examples of the magenta colorant include magenta pigments and magenta dyes such as a monoazo compound; a condensed azo compound; a diketopyrrolopyrrole compound; an anthraquinone compound; a quinacridone compound; a basic dye chelate compound; a naphthol compound; a benzimidazolone compound; a thioindigo compound, and a perylene compound.

Specific examples thereof include C.I. Pigment Red 2, 3, 5, 6, 7, 23, 48:2, 48:3, 48:4, 57:1, 81:1, 122, 144, 146, 150, 166, 169, 177, 184, 185, 202, 206, 220, 221, 238, 254, and 269, and C.I. Pigment Violet 19.

Examples of the cyan colorant include cyan pigments and cyan dyes such as a copper phthalocyanine compound and a derivative thereof, an anthraquinone compound, and a basic dye chelate compound.

Specific examples thereof include C.I. Pigment Blue 1, 7, 15, 15:1, 15:2, 15:3, 15:4, 60, 62, and 66.

A content of the colorant is preferably from 1.0 part by mass to 20.0 parts by mass with respect to 100.0 parts by mass of the binder resin or the polymerizable monomer.

In addition, the toner may contain a magnetic body to form a magnetic toner. In this case, the magnetic body can also play a role of a colorant.

Examples of the magnetic body include iron oxide typified by magnetite, hematite, ferrite, and the like; metals typified by iron, cobalt, nickel, and the like, alloys of these metals with metals such as aluminum, cobalt, copper, lead, magnesium, tin, zinc, antimony, beryllium, bismuth, cadmium, calcium, manganese, selenium, titanium, tungsten, and vanadium, and mixtures thereof.

### Wax

The toner base particle may contain a wax. As the wax, a conventionally known wax can be used without particular limitation. Specific examples thereof include esters of a monohydric alcohol and a monocarboxylic acid, such as behenyl behenate, stearyl stearate, and palmityl palmitate; esters of a divalent carboxylic acid and a monoalcohol, such as dibehenyl sebacate; esters of a dihydric alcohol and a monocarboxylic acid, such as ethylene glycol distearate and hexanediol dibehenate; esters of a trihydric alcohol and a monocarboxylic acid, such as glycerin tribehenate; esters of a tetrahydric alcohol and a monocarboxylic acid, such as pentaerythritol tetrastearate and pentaerythritol tetrapalmitate; esters of a hexahydric alcohol and a monocarboxylic acid, such as dipentaerythritol hexastearate and dipentaerythritol hexapalmitate; esters of a polyfunctional alcohol and a monocarboxylic acid, such as polyglycerin behenate; natural ester waxes such as carnauba wax and rice wax; petroleum-based hydrocarbon wax such as paraffin wax, microcrystalline wax, and petrolatum, and derivatives thereof; hydrocarbon wax obtained by Fischer-Tropsch method and derivatives thereof; polyolefin-based hydrocarbon wax such as polyethylene wax and polypropylene wax, and derivatives thereof; higher aliphatic alcohol; fatty acids such as stearic acid and palmitic acid; and acid amide wax.

From the viewpoint of releasability, the content of the wax is preferably from 1.0 parts by mass to 30.0 parts by mass, and more preferably from 5.0 parts by mass to 20.0 parts by mass, based on 100.0 parts by mass of the binder resin or the polymerizable monomer.

### Charge Control Agent

The toner may contain a charge control agent as long as the characteristics or the effects are not impaired. As the charge control agent, a known charge control agent can be used without particular limitation.

Specific examples thereof include, as a negative charge control agent, a metal compound of an aromatic carboxylic acid such as salicylic acid, alkylsalicylic acid, dialkylsalicylic acid, naphthoic acid, or dicarboxylic acid or a polymer or copolymer having the metal compound of the aromatic carboxylic acid; a polymer or copolymer having a sulfonic acid group, a sulfonate group, or a sulfonic acid ester group; a metal salt or a metal complex of an azo dye or an azo pigment; and a boron compound, a silicon compound, and calixarene.

On the other hand, examples as a positive charge control agent include a quaternary ammonium salt or a polymer type compound having or a quaternary ammonium salt in a side chain; a guanidine compound; a nigrosine-based compound; and an imidazole compound. As the polymer or copolymer having a sulfonate group or a sulfonic acid ester group, a homopolymer of a sulfonate group-containing vinyl-based monomers such as styrene sulfonic acid, 2-acrylamide-2-methylpropane sulfonic acid, 2-methacrylamide-2-methylpropane sulfonic acid, vinyl sulfonic acid, or methacrylic sulfonic acid, or a copolymer of the vinyl-based monomer shown in the section of Binder Resin and the sulfonate group-containing vinyl-based monomer can be used.

A content of the charge control agent is preferably from 0.01 parts by mass to 5.0 parts by mass with respect to 100.0 parts by mass of the binder resin or the polymerizable monomer.

### External Additive

In a case where the toner particle has a silicon polymer composite on a surface thereof, the toner particle exhibits characteristics such as excellent flowability even in a case of having no external additive. However, for the purpose of further improvement, an external additive may be contained as long as the characteristics or the effects are not impaired.

As the external additive, a conventionally known external additive can be used without particular limitation.

Specific examples thereof include original silica fine particles such as wet-process silica and dry-process silica, or silica fine particles obtained by subjecting the original silica fine particles to a surface treatment with a treatment agent such as a silane coupling agent, a titanium coupling agent, or a silicone oil; and resin fine particles such as vinylidene fluoride fine particles and polytetrafluoroethylene fine particles.

A content of the external additive is preferably from 0.1 parts by mass to 5.0 parts by mass with respect to 100.0 parts by mass of the toner particles.

Subsequently, a method for obtaining a toner will be described in detail below. Method for Producing Toner Base Particle

A method for producing the toner base particles (a toner particle before the silicon polymer composite is attached is also referred to as a “toner base particle”) is not particularly limited, and a suspension polymerization method, a dissolution suspension method, an emulsion aggregation method, a pulverization method, or the like can be used.

As an example, a method for obtaining a toner base particle by a suspension polymerization method will be described below.

First, a polymerizable monomer capable of producing a binder resin and, if necessary, various additives are mixed, and a polymerizable monomer composition in which the material is dissolved or dispersed using a disperser is prepared.

Examples of the various additives include a colorant, a wax, a charge control agent, a polymerization initiator, and a chain transfer agent.

Examples of the disperser include a homogenizer, a ball mill, a colloid mill, and an ultrasonic disperser.

Next, the polymerizable monomer composition is put into an aqueous medium containing poorly water-soluble inorganic fine particles, and droplets of the polymerizable monomer composition are prepared using a high-speed disperser such as a high-speed stirrer or an ultrasonic disperser (granulating step).

Thereafter, polymerizable monomers in the droplets are polymerized to obtain a toner base particle (polymerization step).

In the polymerization step, it is preferable that after the polymerizable monomers are polymerized, an organosilicon compound for forming a condensation product of the organosilicon compound be further added to perform condensation polymerization. This makes it easy to achieve the normalized strength of silicon ions (m/z=28) described above.

The polymerization initiator may be mixed when preparing the polymerizable monomer composition, or may be mixed in the polymerizable monomer composition immediately before forming the droplets in an aqueous medium.

In addition, during the granulation of droplets or after completion of the granulation, that is, immediately before the polymerization reaction is started, the polymerization initiator can be added in a state of being dissolved in a polymerizable monomer or another solvent as necessary.

After the polymerizable monomer is polymerized to obtain a binder resin, a desolvation treatment may be performed as necessary to obtain a dispersion of toner base particles.

In a case where the binder resin is obtained by an emulsion aggregation method, a suspension polymerization method, or the like, a known monomer can be used as the polymerizable monomer without any particular limitation. Specific examples thereof include the vinyl-based monomers listed in the section of Binder Resin.

As the polymerization initiator, a known polymerization initiator can be used without particular limitation. Specific examples thereof include the following.

Peroxide-based polymerization initiators typified by hydrogen peroxide, acetyl peroxide, cumyl peroxide, tert-butyl peroxide, propionyl peroxide, benzoyl peroxide, chlorobenzoyl peroxide, dichlorobenzoyl peroxide, bromomethylbenzoyl peroxide, lauroyl peroxide, ammonium persulfate, sodium persulfate, potassium persulfate, diisopropyl peroxycarbonate, tetralin hydroperoxide, 1-phenyl-2-methylpropyl-1-hydroperoxide, triphenyl peracetic acid-tert-hydroperoxide, tert-butyl performate, tert-butyl peracetate, tert-butyl perbenzoate, tert-butyl perphenylacetic acid, tert-butyl permethoxyacetic acid, per-N-(3-toluyl) palmitic acid-tert-butylbenzoyl peroxide, t-butyl peroxy 2-ethylhexanoate, t-butyl peroxypivalate, t-butyl peroxyisobutyrate, t-butyl peroxy neodecanoate, methyl ethyl ketone peroxide, diisopropyl peroxy carbonate, cumene hydroperoxide, 2,4-dichlorobenzoyl peroxide, or lauroyl peroxide; azo-based or diazo-based polymerization initiators typified by 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, and azobisisobutyronitrile; and the like.

### Method for Attaching Silicon Polymer Composite

Examples of a method for attaching the silicon polymer composite to the toner base particle will be described below. Examples thereof include a method for obtaining a silicon polymer composite by reacting a metal compound serving as a metal source with a silicon compound (preferably an organosilicon compound) in an aqueous medium in which toner base particles are dispersed, and a method for attaching a silicon polymer composite onto toner particles by a mechanical external force in a dry or wet manner.

(1) Method for Obtaining Silicon Polymer Composite by Reacting Metal Compound Serving as Metal Source with Silicon Compound in Aqueous Medium in which Toner Base Particles are Dispersed

For example, a compound containing a metal element and a silicon compound are added to and mixed with a dispersion of the toner base particles to react the compound containing a metal element and the silicon compound, and a reaction product is precipitated, and at the same time, the dispersion is stirred, so that the reaction product is attached to the toner base particle.

### (2) Method for Attaching Silicon Polymer Composite to Surface of Toner Base Particle by Mechanical External Force in Dry or Wet Manner

For example, using a high-speed stirrer that applies a shear force to a powder or an aqueous medium, such as a FM mixer, MECHANO HYBRID (manufactured by NIPPON COKE & ENGINEERING CO., LTD), a super mixer, NOBILTA (manufactured by Hosokawa Micron Ltd), or T.K. Homomixer (manufactured by Tokushu Kika Kogyo Co., Ltd), the silicon polymer composite is attached to the toner base particles while applying a force to disintegrate the silicon polymer composite.

Among them, (1) the method for obtaining a silicon polymer composite by reacting a metal compound serving as a metal source with an organosilicon compound in an aqueous medium in which toner base particles are dispersed is preferable. By using the above method, the silicon polymer composite can be uniformly dispersed on the surface of the toner particle. Since the charge injection sites are uniformly present on the surface of the toner particle, charges can be uniformly and efficiently injected into a toner, and the charge rising performance is improved, so that fogging can be further suppressed.

In addition, according to the above method, since the silicon polymer composite is attached to the toner base particle before the growth of the silicon polymer composite generated in the aqueous medium is completed, the silicon polymer composite is firmly fixed on the toner base particle as compared with a case where the silicon polymer composite prepared in advance is attached by an external mechanical force. As a result, it is possible to obtain a toner which does not cause the silicon polymer composite to be detached from a base even during long-term use, and can exhibit the effect of the present invention of improving the fogging suppression over long-term use, and is excellent in durability.

Examples of the method (1) will be described below.

In a case where the silicon polymer composite is attached onto the toner base particle by a method for obtaining a silicon polymer composite by reacting a metal compound serving as a metal source with a silicon compound in an aqueous medium in which the toner base particle is dispersed, it is preferable to include the following steps.

That is, the method for producing a toner preferably includes: a step of dispersing a toner base particle in an aqueous medium to obtain a toner base particle-dispersed solution (Step 1); and a step of mixing a metal compound and a silicon compound (or a hydrolyzate thereof) in the toner base particle-dispersed solution, and reacting the metal compound and the silicon compound in the toner base particle-dispersed solution to attach a silicon polymer composite onto the toner base particle (Step 2).

Examples of a method for obtaining the toner base particle-dispersed solution in Step 1 include a method in which a dispersion of the toner base particles produced in the aqueous medium is used as it is, and a method in which dried toner base particles are charged into an aqueous medium and mechanically dispersed. In a case where the dried toner base particles are dispersed in an aqueous medium, a dispersion aid may be used.

As the dispersion aid, a known dispersion stabilizer, a surfactant, or the like can be used. In specific, examples of the dispersion stabilizer include an inorganic dispersion stabilizer such as tricalcium phosphate, hydroxyapatite, magnesium phosphate, zinc phosphate, aluminum phosphate, calcium carbonate, magnesium carbonate, calcium hydroxide, magnesium hydroxide, aluminum hydroxide, calcium metasilicate, calcium sulfate, barium sulfate, bentonite, silica, and alumina, and an organic dispersion stabilizer such as polyvinyl alcohol, gelatin, methyl cellulose, methyl hydroxypropyl cellulose, ethyl cellulose, sodium salt of carboxymethyl cellulose, and starch. Also, examples of the surfactant include an anionic surfactant such as an alkyl sulfate salt, alkyl benzene sulfonate, and a fatty acid salt; a nonionic surfactant such as a polyoxyethylene alkyl ether and a polyoxypropylene alkyl ether; and a cationic surfactant such as an alkylamine salt and a quaternary ammonium salt. Among them, it is preferable to contain an inorganic dispersion stabilizer, and it is more preferable to contain a dispersion stabilizer containing a phosphate such as tricalcium phosphate, hydroxyapatite, magnesium phosphate, zinc phosphate, or aluminum phosphate.

In Step 2, the silicon compound may be added to the toner base particle-dispersed solution as it is, or may be added to the toner base particle-dispersed solution after hydrolysis. Among them, since the reaction between the metal compound and the silicon compound is easily controlled, and the amount of the silicon compound remaining in the toner base particle-dispersed solution can be reduced, the silicon compound is preferably added after hydrolysis.

The hydrolysis is preferably performed in an aqueous medium whose pH is adjusted using known acid and base. It is known that the hydrolysis of the organosilicon compound has pH dependency, and the pH in the case of performing the hydrolysis is preferably appropriately changed depending on the type of the organosilicon compound. For example, in a case where methyltriethoxysilane is used as the organosilicon compound, the pH of the aqueous medium is preferably from 2.0 to 6.0.

Specific examples of the acid for adjusting the pH include an inorganic acid such as hydrochloric acid, hydrobromic acid, hydroiodic acid, hypochlorous acid, chlorous acid, chloric acid, perchloric acid, hypobromous acid, bromous acid, bromic acid, perbromic acid, hypoiodous acid, iodous acid, iodic acid, periodic acid, sulfuric acid, nitric acid, phosphoric acid, and boric acid, and an organic acid such as acetic acid, citric acid, formic acid, gluconic acid, lactic acid, oxalic acid, and tartaric acid.

Specific examples of the base for adjusting the pH include a hydroxide of alkali metal, such as potassium hydroxide, sodium hydroxide, and lithium hydroxide and an aqueous solution thereof, a carbonate of alkali metal, such as potassium carbonate, sodium carbonate, and lithium carbonate and an aqueous solution thereof, a sulfate of alkali metal, such as potassium sulfate, sodium sulfate, and lithium sulfate and an aqueous solution thereof, a phosphate of alkali metal, such as potassium phosphate, sodium phosphate, and lithium phosphate and an aqueous solution thereof, a hydroxide of alkaline earth metal, such as calcium hydroxide and magnesium hydroxide and an aqueous solution thereof, and amines such as ammonia and triethylamine.

The reaction between the metal compound and the silicon compound in Step 2 is preferably controlled by adjusting the pH of the toner base particle-dispersed solution. It is known that the reaction between the metal compound and the silicon compound has pH dependency, and the pH in the case of performing the reaction between the metal compound and the silicon compound is preferably appropriately changed depending on the type of the metal compound or the silicon compound.

For example, in a case where titanium lactate is used as the metal compound and methyltriethoxysilane is used as the silicon compound, the pH of the aqueous medium is preferably from 6.0 to 12.0. As the acid and base for adjusting the pH, the acid and base exemplified in the section of hydrolysis can be used.

In Step 2, the pH when the metal compound and the silicon compound (or a hydrolyzate thereof) are mixed in the toner base particle-dispersed solution is preferably a pH at which the condensation of the silicon compound hardly proceeds, and is preferably, for example, 2.0 to 6.0 and more preferably 4.0 to 6.0. Then, it is preferable that the metal compound and the silicon compound (or a hydrolyzate thereof) be mixed with the toner base particle-dispersed solution and pH control be performed. The pH in Step 2 is preferably 8.5 to 10.5, and more preferably 9.0 to 10.0.

The pH adjustment time in the case of performing the pH control is preferably 1 to 90 minutes, and more preferably 1 to 40 minutes. By changing the pH in the adjustment time, the hydrolysis of the metal compound can be advanced while suppressing the condensation reaction between the metal compounds.

The condensation reaction in Step 2 is preferably about 10° C. to 100° C., and more preferably 30° C. to 70° C. The above ME, SiE, MX, Mmax, Mave, and the like can be controlled as desired by adjusting conditions such as the addition amount or the addition timing of each material, the temperature, and the pH.

(ME/SiE)/MX can be increased by increasing the pH in Step 2 or increasing the amount of the silane coupling agent to a certain amount or more. (ME/SiE)/MX can be reduced by lowering the pH or temperature in Step 2 or reducing the addition amount of the metal compound.

MX can be increased by increasing the addition amount of the metal compound. MX can be reduced by reducing the addition amount of the metal compound.

In addition, Mmax/Mave can be increased by increasing the addition amount of the silane coupling agent or by lowering the reaction temperature or pH. Mmax/Mave can be reduced by increasing the amount of the metal compound or increasing the reaction temperature or pH.

In addition, the silicon polymer composite preferably contains a polyhydric acid metal salt. In Step 2, when the polyhydric acid is present in the toner base particle-dispersed solution, the reaction between the metal compound and the polyhydric acid also proceeds simultaneously to generate a polyhydric acid metal salt. As a result, the polyhydric acid metal salt can be contained in the silicon polymer composite. Since the condensation reaction between the silicon compounds, the reaction between the metal compound and the silicon compound, and the reaction between the metal compound and the polyhydric acid occur competitively, the reaction can be controlled as desired by adjusting conditions such as the addition amount or the addition timing of each material, the temperature, and the pH.

For example, a dispersion aid containing a polyhydric acid ion such as a phosphate ion can be selected as the dispersion aid used in Step 1. The toner base particle-dispersed solution obtained in Step 1 can contain polyhydric acid ions. Thus, when the silicon polymer composite is reacted with the silicon compound in Step 2, the polyhydric acid ion and the metal compound can be reacted.

In addition, in order to remarkably exhibit the above-described effects, it is preferable to control the shape of the silicon polymer composite, the amount of metal atoms, the exposure ratio of metal atoms, the dispersibility of metal atoms, and the chemical bond between metal atoms and the silicon polymer. These can be controlled as desired by adjusting the production conditions such as the addition amount or addition timing of each material, the temperature, and the pH in Step 1 and Step 2 described above.

As the metal compound, the silicon compound, and the polyhydric acid used in the above method, the metal compound, the silicon compound, and the polyhydric acid described above can be used, respectively.

Subsequently, a method for measuring each physical property of a photosensitive member and the toner according to the present invention will be described in detail below. In the description of each measurement method, the toner, the toner particle, or the toner base particle is also referred to as “toner or the like.”

### Method for Observing Surface of Toner

The surface of the toner is observed as follows.

The surface of the toner or the like is observed at a magnification of 50,000 times using a scanning electron microscope (SEM, apparatus name: JSM-7800F, manufactured by JEOL Ltd). Then, mapping for elements on the surface of the toner or the like are performed using energy dispersive X-ray spectroscopy (EDX). The presence of the silicon polymer composite and the polyhydric acid metal salt on the surface of the toner is confirmed from the presence position of each element confirmed in the element mapping image of the SEM obtained and the presence position of each element confirmed in the EDX mapping image of the toner obtained by “Method for Observing Cross Section of Toner” which will be described later.

Specifically, the mapping image of silicon is compared with the mapping image of the metal element, and the presence of silicon and the metal element in the same particle makes it possible to confirm that the metal atom and the silicon atom are present as a silicon polymer composite.

In addition, when the mapping image of the metal element is compared with the mapping image of phosphorus when the element contained in the polyhydric acid, for example, phosphoric acid is used as the polyhydric acid, and the two images coincide with each other, it can be confirmed that the polyhydric acid metal salt is contained.

### Method for Observing Cross Section of Toner (Measurement of MX)

First, a toner is sprayed onto a cover glass (Matsunami Glass Ind., square cover glass No. 1) in a single layer, and an Os film (5 nm) and a naphthalene film (20 nm) are applied to the toner as a protective film using an osmium plasma coater (Filgen, OPC80T). Next, a PTFE tube (inner diameter 1.5 mm×outer diameter 3 mm×3 mm) is filled with a photocurable resin D800 (JEOL Ltd), and the cover glass is gently placed on the tube in a direction in which the toner comes into contact with the photocurable resin D800.

After the resin is cured by irradiation with light in this state, the cover glass and the tube are removed to form a cylindrical resin in which the toner is embedded in the outermost surface. The toner is cut at a cutting speed of 0.6 mm/s from the outermost surface of the cylindrical resin by a length of a radius of the toner (4.0 μm in a case where the weight-average particle diameter (D4) is 8.0 μm) with an ultrasonic ultramicrotome (Leica, UC7) to obtain a cross section of the toner. Next, cutting was performed so as to obtain a film thickness of 100 nm to prepare a thin piece sample of a toner cross section. By performing the cutting with such a method, a cross section of the toner central portion can be obtained.

The thin piece sample was observed in a field of view in which the outermost surface of the toner can be confirmed at a magnification of 400,000 times in a STEM mode of a scanning transmission electron microscope (JEOL Ltd., JEM2800) connected to an EDS analyzer (energy dispersive X-ray analyzer).

Spectra of constituent elements of the observed cross section of the toner were collected using an EDS analyzer to prepare an EDS mapping image. Spectrum collection and analysis were performed using NSS (ThermoFischer Scientific). For collection conditions, an acceleration voltage was 200 kV, a probe size was appropriately selected to be 1.0 nm or 1.5 nm so that a dead time was from 15 to 30, a mapping resolution was set to 256×256, and the number of frames was set to 500. The EDS mapping images were acquired from 30 toner cross sections.

In the EDS mapping image thus obtained, signals derived from the constituent elements of the silicon polymer composite and the polyhydric acid metal salt particles are confirmed on the contour of the cross section of the toner. Thereby, the presence or absence of formation of a protruded portion on the surface of the toner and the presence of the silicon polymer composite and the polyhydric acid metal salt particles are confirmed. Further, the composition of the protruded portion, that is, whether the protrusion is formed of a silicon polymer composite is confirmed.

Furthermore, by analyzing the EDS mapping image obtained as described above, a ratio of the number of the metal atom to the sum of the number of a silicon atom and the metal atom in the silicon polymer composite can be calculated.

First, the “Extract from line” button of the NSS is pressed, and an analysis range is selected freehand. Specifically, a base line is drawn by tracing an interface between the toner base particle and the silicon polymer composite present on the surface of the toner base particle, and a parallel line is drawn at a position of 200 nm in an outer contour direction of the toner parallel to the base line. A range sandwiched between the base line and the parallel line is selected as an analysis range, and this range is a region outside the contour of the toner base particle.

When the analysis range of the toner can be selected, “Quantification of spectrum” button is pressed to automatically calculate the ratio (atom %) of the silicon atoms and the metal atoms in the selected range. In this case, silicon and the metal element are selected as elements to be analyzed. The ratio MX of the number of the metal atom to the sum of the numbers of a silicon atom and the metal atom in the silicon polymer composite can be calculated based on values of the ratio (atom %) of the silicon atom and the ratio (atom %) of the metal atom indicated in the quantitative result.

That is, MX=(the number of the metal atom)/(Sum of the numbers of a silicon atom and the metal atom). An arithmetic average value of 30 toner cross sections is adopted.

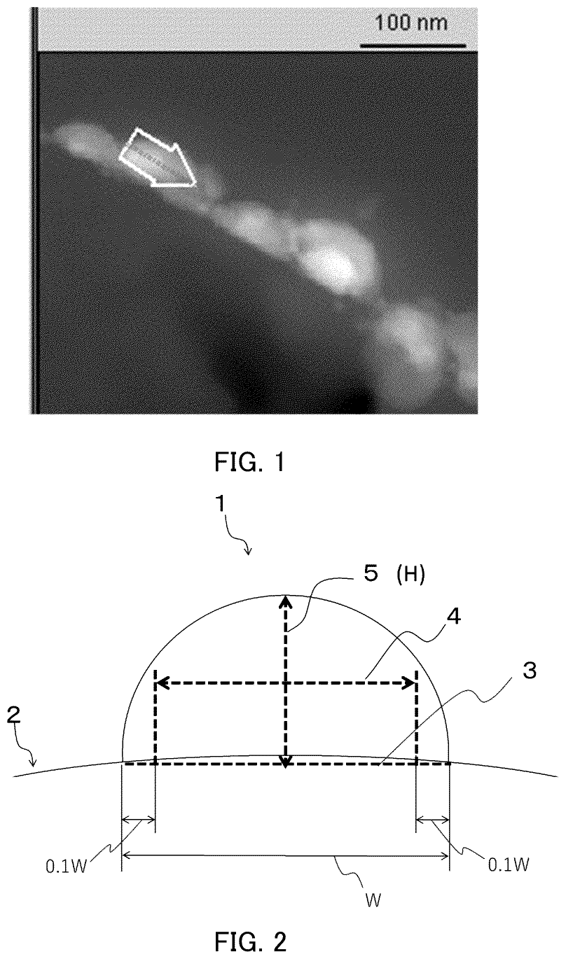

FIG. 1 is an example of a STEM image diagram of a toner used in Example. In FIG. 1, a group of white protrusion shapes is a silicon polymer composite, and the lower left thereof is a toner base particle portion excluding the protrusion shape.

When the silicon polymer composite is present in a hemispherical shape at the interface between the silicon polymer composite and the binder resin as shown in FIG. 1, it was determined that “the silicon polymer composite fixes on the surface of the toner base particle in a protrusion shape”.

### Method for Evaluating Dispersibility of Specific Metal Atom (Measurement of Mmax and Mave)

The fine dispersibility of the specific metal atom in the silicon polymer composite can be quantified and evaluated using the EDS mapping image obtained in “Method for Observing Cross Section of Toner.”

First, end points of the interface formed by the image of the toner base particle and the image of the silicon polymer composite observed in the EDS mapping image are connected by a straight line to define a base line. Also, among the perpendicular lines connecting the base line and the outer surface of the image of the silicon polymer composite, a perpendicular line L1 having the maximum length is defined.

Further, when a width of the image of the silicon polymer composite, which is a length of the base line, is defined as W, a line segment L2 connecting two points on an inner side of 0.1 W from respective end portions of the base line is defined on the base line.

Furthermore, a region in which a line segment overlaps the image of the silicon polymer composite when the line segment L2 is moved to a position of a midpoint of the perpendicular line L1 in parallel with the base line in a direction in which the perpendicular line L1 extends is defined as “region X”.

In addition, information on a detected strength (net count) of atoms on the region X is obtained. Specifically, when pressing the “Line extraction” button, drawing the line segment, and pressing the “Quantification of spectrum” button, the strength of the specific metal atom on the line segment is automatically calculated. In this case, the specific metal element is selected as an element to be analyzed.

The maximum value of the net counts of the specific metal element obtained from the line segment is defined as Mmax, and the average value is defined as Mave.

### Method for Measuring Ratio (ME/SiE) of the Number of Specific Metal Atom to the Number of Silicon Atom

The ratio of the number of a silicon atom and the ratio of the number of the specific metal atoms, with respect to the sum of the numbers of a carbon atom, an oxygen atom, a silicon atom, a phosphorus atom, and a specific metal atom on the surface of the toner are calculated as follows.

Conditions in a case of using a titanium atom as the specific metal atom will be exemplified below. In a case where other metal atoms are used, a quantitative value is calculated using a peak corresponding to a peak position of a predetermined specific metal atom.

Elemental analysis of the surface of the toner is performed using the following apparatus under the following conditions.
Measuring apparatus: Quantum 2000 (Trade name, and manufactured by ULVAC-PHI, INC)
X-ray source: monochrome Al Kα
Xray Setting: 100 μmφ (25 W (15 KV))
Photoelectron take-off angle: 45 degrees
Neutralization condition: combined use of neutralization gun and ion gun
Analysis area: 300×200 μm
Pass Energy: 58.70 eV
Step size: 1.25 eV
Analysis software: Maltipak (PHI)

Here, for the calculation of the number of atoms (atom %) including a silicon atom and a titanium metal atom, peaks of C 1c (B.E.280 to 295 eV), O 1s (B.E.525 to 540 eV), Si 2p (B.E.95 to 113 eV), P 2p (B.E.129 to 138 eV), and Ti 2p (B.E.456 to 470 eV) were used. The sum of the numbers of a carbon atom, an oxygen atom, a silicon atom, a phosphorus atom, and a titanium atom is calculated. With respect to the sum of numbers of these atoms, the ratio of the number of a silicon atom is defined as SiE, and the ratio of the number of a titanium atom is defined as ME.

That is, SiE=(the number of silicon atom)/(Sum of the numbers of a carbon atom, an oxygen atom, a silicon atom, a phosphorus atom, and a titanium atom).

Also, ME=(the number of titanium atom)/(Sum of the numbers of a carbon atom, an oxygen atom, a silicon atom, a phosphorus atom, and a titanium atom).

ME/SiE is calculated from the obtained ME and SiE.

Method for Confirming that Silicon Polymer Composite Contains Silicon Polymer

Whether the silicon polymer composite contained in the toner or the like contains a silicon polymer is confirmed by 13C-NMR and 29Si-NMR.

An apparatus to be used and measurement conditions are shown below.

### Measurement Conditions

Apparatus: AVANCE III 500 manufactured by BRUKER
Probe: 4 mm MAS BB/1H
Measurement temperature: room temperature
Sample rotation speed: 6 kHz
Sample: 150 mg of a measurement sample (tetrahydrofuran THF insoluble component such as a toner or the like for NMR measurement) is placed in a sample tube having a diameter of 4 mm.

The presence or absence of the silicon polymer is confirmed by this method. When a signal derived from the silicon polymer can be confirmed, it is determined that the silicon polymer composite contains the silicon polymer.

### ¹³C-NMR (Solid) Measurement Conditions

Measurement nucleus frequency: 125.77 MHz
Reference material: Glycine (external standard: 176.03 ppm)
Observation width: 37.88 kHz
Measurement method: CP/MAS
Contact time: 1.75 ms
Repetition time: 4 s
Number of integrations: 2048 times
LB value: 50 Hz

### Method for Measuring 29Si-NMR (Solid)

### Measurement Conditions

Apparatus: AVANCE III 500 manufactured by BRUKER
Probe: 4 mm MAS BB/1H
Measurement temperature: room temperature
Sample rotation speed: 6 kHz
Sample: 150 mg of a measurement sample (THF insoluble component of toner particles for NMR measurement) is placed in a sample tube having a diameter of 4 mm.
Measurement nucleus frequency: 99.36 MHz
Reference material: DSS (external standard: 1.534 ppm)
Observation width: 29.76 kHz
Measurement method: DD/MAS, CP/MAS
29Si 90° Pulse width: 4.00 μs@−1 dB
Contact time: 1.75 ms to 10 ms
Repeat time: 30 s (DD/MASS), 10 s (CP/MAS)
Number of integrations: 2048 times
LB value: 50 Hz

### Method for Measuring Conductivity of Silicon Polymer Composite (Powder)

The electrical characteristics of the silicon polymer composite are evaluated by measuring a capacitance and conductivity of a powder bulk by impedance measurement using a double ring method with parallel plate electrodes.

As an apparatus, a powder measuring jig including a 4-terminal sample holder SH2-Z (manufactured by TOYO Corporation) and a torque wrench adapter SH-TRQ-AD (optional), and a material test system ModuLab XM MTS (manufactured by Solartron) are used. In addition, a noise cut transformer NCT-I3 1.4kVA (manufactured by Denken Seiki Kenkyusho Co., Ltd) for suppressing commercial power supply noise and a shield box for suppressing electromagnetic wave noise are used.

The powder measuring jig is configured such that a resistance of 0.1Ω to 1 TΩ can be measured for an electric signal of 500 Vp-p at maximum and DC to 1 MHz, by using a 4-terminal sample holder and an optional torque wrench adapter SH-TRQ-AD, and using an upper electrode (solid electrode having a diameter of 25 mm) SH-H25AU and a lower electrode (center electrode having a diameter of 10 mm; Guard electrode having a diameter of 26 mm) SH-2610AU for liquid/powder, as parallel plate electrodes. In addition, in order to perform a pressure adjustment of the powder sample, a torque wrench adapter SH-TRQ-AD (manufactured by TOYO Corporation) is attached to a micrometer provided in the 4-terminal sample holder and used for measuring the film thickness between the upper and lower electrodes. As a torque driver used for pressure management, a torque driver RTD15CN and a 6.35 mm square bit are used, and a tightening torque in powder measurement can be managed to 6.5 cN·m.

In the measurement of the electrical AC characteristics, impedance measurement is performed using a material test system ModuLab XM MTS (manufactured by Solartron). The ModuLab XM MTS is configured of a control module XM MAT 1 MHz, a femto current module XM MFA, and a frequency response analysis module XM MRA 1 MHZ, and XM-studio MTS Ver. 3.4 manufactured by Solartron is used for control software.

In a case of a powder material such as a silicon polymer composite, an AC level is set within a range of from 7 mVrms to 70 mVrms so as to be in a current range measurable by a measuring instrument. In addition, Normal Mode in which only measurement is performed is set, a DC bias of 0 V, a sweep frequency of 1 MHz to 100 Hz (12 points/decade), and a measurement integration time of 1 second are set.

The impedance characteristics, which are electrical AC characteristics, are measured under the above measurement conditions.

By performing the measurement under the above conditions, the impedance characteristics of the powder sample at a film thickness d according to the pressurizing torque and the measurement electrode S having a diameter of 10 mm of a powder measurement jig used, can be obtained.

From the impedance characteristics of the obtained powder sample, a capacitance C and a conductance (conductivity) G are obtained. From the obtained capacitance C, the conductance (conductivity) G, and the geometric shape of the powder measurement jig (the electrode size S of the parallel flat plate and the sample film thickness), a conductivity, which is an electrical property, is determined.

In a case where the 4-terminal sample holder SH2-Z is used for the first time, since there is an individual difference in the 4-terminal sample holder SH2-Z used for the powder measurement jig, it is necessary to perform the following two verifications in order to find an optimal measurement condition.

The first verification is a film thickness dependent characteristic of the 4-terminal sample holder. The air thickness (distance between electrodes of the upper part and the lower part) dependence is measured, an error between a theoretical value and a measured value of the capacitance is confirmed, and the optimum range in which the measurement error is minimized or a film thickness at which the measurement error becomes an optimum value is identified.

The second verification is measurement of a mechanical error. The measurement of the powder sample applies a torque-controlled load to keep a volume density constant. On the other hand, in the measurement of air, there is no load. In this case, a film thickness error occurs due to an influence of dimensions such as mechanical machining accuracy. Therefore, offset values of the tightening torque management value (6.5 cN·m in this jig) in the load state and the no-load state are confirmed, and an appropriate film thickness range of the powder measurement jig at the time of pressurization is identified to obtain highly reliable data.

Specific sample preparation and measurement procedures are as follows.
(1) A powder sample is placed on a center electrode portion of the lower electrode and formed into a trapezoidal shape having a height of 5 mm.
(2) The lower electrode on which the powder sample is placed is attached to the 4-terminal sample holder SH2-Z, and the upper electrode is lowered.
(3) At this time, the upper electrode is lowered to an upper end portion of the powder sample while being kept constant so as not to inadvertently rotate.
(4) Smoothing is performed so that the powder sample becomes smooth while rotating the upper electrode left and right.
(5) A rotation direction of the upper electrode is maintained in a uniform constant direction while adjusting the film thickness to a predetermined thickness using a micrometer.
(6) Pressurization is performed using a torque driver with a tightening torque controlled to 6.5 cN·m.
(7) The film thickness of the powder sample is measured using a micrometer.
(8) The impedance measurement is performed under the above conditions.
(9) After the measurement is completed, the upper electrode is raised, and the lower electrode is removed. At this time, the lower electrode is removed with sufficient care so that the powder sample does not enter the lower electrode contact terminal of the 4-terminal sample holder, and the lower electrode is protected with a masking tape.
(10) The upper and lower electrodes are cleaned.
(11) The masking tape is removed and the lower electrode is attached.

The measurement is performed at 25° C.

A specific data processing procedure is as follows.
(12) From the impedance characteristics measured in Step (8), a complex admittance Ym=Gm+jo Cm is obtained. (Ym is the measured admittance. Gm is the measured conductance, and Cm is the measured capacitance. In addition, ω represents an angular frequency, and j represents an imaginary number of a complex number).
(13) The conductivity K can be obtained from the conductance Gm and the geometric shape (measurement electrode area S and measurement film thickness d) of the powder measurement jig.

$$κ = Gm \times d / S$$

Hereinafter, a method for quantifying conductivity, which is an electrical property, will be described.

### Quantification Method for Conductivity

A powder sample having both capacitance and conductivity can be recognized as an RC parallel circuit model, and the conductivity k in a low frequency range shows a constant value. In the present disclosure, the conductivity at a frequency of 10 kHz was measured.

### Preparation of Silicon Polymer Composite (Powder)

The silicon polymer composite is recovered from the toner particles by the following procedure, and can be used as a sample for dielectric constant measurement.

A method for recovering the silicon polymer composite from the toner particles will be described. 10.0 g of toner particles are weighed, and stirred and mixed with 100 mL of N,N-dimethylformamide (DMF) for 60 minutes. The mixture may be heated to 80° C. as necessary during stirring and mixing. After stirring for 60 minutes, a mixed solution returned to room temperature is transferred to a glass tube for a swing rotor (50 mL), and centrifuged in a centrifuge at 3,500 rpm for 30 minutes. In the glass tube after centrifugation, a DMF insoluble component containing a silicon polymer composite is present in a lower layer portion. The insoluble component is recovered. This operation is repeated three times. Thereafter, the recovered insoluble component is dispersed in 100 mL of RO water, and centrifugation is performed again in a centrifuge at 3,500 rpm for 30 minutes. At this time, insoluble matter in the lower layer portion of the glass tube is recovered and dried to obtain a silicon polymer composite.

In Examples described later, a silicon polymer composite-dispersed solution was prepared under conditions where no toner base particles were present, and the conductivity of the silicon polymer composite obtained by dehydration was measured. A method for dehydrating the silicon polymer composite-dispersed solution is as follows. First, a solid content is extracted from the silicon polymer composite-dispersed solution by centrifugation. Thereafter, a step of dispersing again in ion-exchanged water and extracting the solid content by centrifugation is repeated three times to remove ions such as sodium. The mixture is dispersed again in ion-exchanged water and dried by spray drying to obtain a silicon polymer composite.

### Method for Measuring the Weight-Average Particle Diameter (D4) and the Number-Average Particle Diameter (D1)

The weight-average particle diameter (D4) and the number-average particle diameter (D1) of toner and the like are calculated as follows.

The measuring device used herein is a precision particle size distribution measuring device “Coulter Counter Multisizer 3” (registered trademark, by Beckman Coulter, Inc.) relying on a pore electrical resistance method and equipped with a 100 μm aperture tube.

Measurement conditions are set, and measurement data analyzed, using dedicated software (Beckman Coulter Multisizer 3, Version 3.51″, by Beckman Coulter, Inc.) ancillary to the device. The measurements are performed in 25,000 effective measurement channels.

An electrolytic aqueous solution that can be used in the measurements results from dissolution of special-grade sodium chloride to a concentration of about 1.0% in ion-exchanged water, and may be for instance “ISOTON II” (by Beckman Coulter, Inc.).

The dedicated software is set up as follows, prior to measurement and analysis.

In the screen of “Modification of the Standard Measurement Method (SOMME)” of the dedicated software, a Total Count of the Control Mode is set to 50,000 particles, the number of measurements is set to one, and a Kd value is set to a value obtained using “Standard particles 10.0 μm” (by Beckman Coulter Inc. The “Threshold/Noise Level Measurement Button” is pressed, to thereby automatically set a threshold value and a noise level. Then the current is set to 1,600 uA, the gain is set to 2, the electrolytic aqueous solution is set to ISOTON II, and “Flushing of the Aperture Tube Following Measurement” is ticked.

In the screen for “Setting of Conversion from Pulses to Particle Diameter” of the dedicated software, the Bin Interval is set to a logarithmic particle diameter, the Particle Diameter Bin is set to 256 particle diameter bins, and the Particle Diameter Range is set to a range from 2 μm to 60 μm.

The concrete measuring method is as follows.

(1) Herein 200.0 mL of the electrolytic aqueous solution are placed in a dedicated 250 mL round-bottomed glass beaker ancillary to Multisizer 3, and the beaker is set on a sample stand and is stirred counterclockwise with a stirrer rod at 24 rotations/second. Dirt and air bubbles are then removed from the aperture tube by way of the “Aperture Flush” function of the dedicated software.

(2) Then about 30.0 mL of the electrolytic aqueous solution are placed in a 100 mL flat-bottomed glass beaker. To the beaker there is added a dispersing agent in the form of 0.3 mL of a dilution of “Contaminon N” (10 mass % aqueous solution of a pH-7 neutral detergent for precision measuring instruments, made up of a nonionic surfactant, an anionic surfactant and an organic builder, by Wako Pure Chemical Industries, Ltd.), diluted thrice by mass in ion-exchanged water.

(3) An ultrasonic disperser is prepared having an electrical output of 120 W, “Ultrasonic Dispersion System Tetora 150” (by Nikkaki Bios Co., Ltd.), internally equipped with two oscillators that oscillate at a frequency of 50 kHz and are disposed at phases offset by 180 degrees. Then 3.3 L of ion-exchanged water are charged into a water tank of the ultrasonic disperser, and 2.0 mL of Contaminon N are added to the water tank.

(4) The beaker in (2) is set in a beaker-securing hole of the ultrasonic disperser, which is then operated. The height position of the beaker is adjusted so as to maximize a resonance state at the liquid surface of the electrolytic aqueous solution in the beaker.

(5) With the electrolytic aqueous solution in the beaker of (4) being ultrasonically irradiated, about 10 mg of the toner or the like are then added little by little to the electrolytic aqueous solution, to be dispersed therein. The ultrasonic dispersion treatment is further continued for 60 seconds. The water temperature in the water tank during ultrasonic dispersion is adjusted as appropriate so as to range from 10° C. to 40° C.

(6) The electrolytic aqueous solution in (5) having the toner or the like dispersed therein is added dropwise, using a pipette, to the round-bottomed beaker of (1) set in the sample stand, and the measurement concentration is adjusted to about 5%. A measurement is then performed until the number of measured particles reaches 50,000.

(7) Measurement data is analyzed using the dedicated software ancillary to the apparatus, to calculate the weight-average particle diameter (D4) and the number-average particle diameter (D1). The “Average Diameter” in the “Analysis/Volume Statistics (arithmetic mean)” screen, with Graph/volume % set in the dedicated software, yields herein the weight-average particle diameter (D4). The “Average Diameter” in the “Analysis/Number Statistics (arithmetic mean)” screen, with Graph/number % set in the dedicated software, yields herein the number-average particle diameter (D1).

### Method for Measuring Normalized Strength of Silicon Ion Present on Toner Base Particle Surface

The normalized strength of silicon ions (m/z=28) on the toner base particle surface is confirmed by a time-of-flight secondary ion mass spectrometer (TOF-SIMS). An apparatus used and measurement conditions are shown below.

The measurement is performed on the toner base particles obtained by washing the toner base particle-dispersed solution with hydrochloric acid and then filtering the toner base particle-dispersed solution while washing the toner base particle-dispersed solution with ion-exchanged water.
Measuring apparatus: nanoTOF II (Trade name, manufactured by ULVAC-PHI, Inc)
Primary ion species: Bi³⁺⁺
Acceleration voltage: 30 kV
Primary ion current: 0.05 pA
Repetition frequency: 8.2 kHz
Raster mode: Unbunch
Raster size: 100 μm×100 μm
Measurement mode: Positive
Neutralization electron gun: used
Measurement time: 600 seconds
Sample preparation: fixing toner base particles to indium sheet
Sample pretreatment: none

Evaluation is performed from a mass number of Si ions and fragment ions caused by a resin or a silane compound using standard software (TOF-DR) manufactured by ULVAC-PHI, Inc.

The silicon ion normalized strength (m/z=28) can be derived by dividing the ionic strength derived from silicon (m/z=28) having a mass number of 28 by the total ionic strength at a mass number of 0.5 to 1850.

### Method for Measuring Normalized Strength of Silicon Ion Present Inside Toner Particle

Normally, TOF-SIMS is a surface analysis method, and data in a depth direction is data of about 1 nm. Therefore, the strength inside the toner base particle is measured after the toner base particle is sputtered by an argon gas cluster ion beam (Ar-GCIB) and the surface is cut.

The silicon ion normalized strength (m/z 28) measured under the same conditions as in the “Method for Measuring Normalized Strength of Silicon Ion Present on Toner Base Particle Surface” after sputtering is performed on the toner base particle under the following condition (A) is defined as a value of the silicon ion normalized strength present inside the toner base particle.

The sputtering conditions are as follows.

### Condition (A)

Acceleration voltage: 5 kV
Current: 6.5 nA
Raster size: 600×600 μm
Irradiation time: 5 sec/cycle
Sputtering time: 250 sec

In addition, when a PMMA film was sputtered under the same condition in advance and the cutting depth was confirmed, it was confirmed that cutting was performed at 80 nm for 250 s.

### Removal of External Additive in Toner

If necessary, an external additive can be removed from the toner by the following procedure and used for each analysis.

160 g of sucrose (manufactured by Kishida Chemical Co., Ltd) is added to 100 mL of ion-exchanged water and dissolved with hot water to prepare a sucrose concentrate. 31 g of the sucrose concentrate and 6 mL of Contaminon N (10 mass % aqueous solution of neutral detergent for washing precision measuring instrument at pH 7 including a nonionic surfactant, an anionic surfactant, and an organic builder, manufactured by Wako Pure Chemical Industries, Ltd) are put into a centrifuge tube to prepare a dispersion.

1 g of toner is added to the dispersion, and a toner lump is loosened with a spatula or the like. A centrifuge tube is shaken for 30 minutes with a shaker (“KM Shaker” manufactured by Iwaki Sangyo Co., Ltd) under the condition of 350 reciprocations per minute. After the shaking, the solution was transferred to a glass tube for a swing rotor (50 mL), and centrifuged for 30 minutes under conditions of 58.33 S⁻¹ with a centrifuge (H-9R; Kokusan Co., Ltd.). In the glass tube after centrifugation, toner particles are present in the uppermost layer, and external additives are present on an aqueous solution side of the lower layer. The toner particles in the uppermost layer are collected and filtered, washed with 2 L of ion-exchanged water warmed to 40° C., and the washed toner particles are extracted.

### Method for Separating THF Insoluble Component of Toner or Like for Infrared Spectroscopy (IR) Analysis

A tetrahydrofuran (THF) insoluble component such as toner or the like was separated as follows.

10.0 g of the toner or the like is weighed, placed in a cylindrical filter paper (No. 86R manufactured by Toyo Filter Paper Co., Ltd), and subjected to a Soxhlet extractor. The mixture was extracted for 20 hours using 200 mL of THE as a solvent, and the filtrate in the cylindrical filter paper was vacuum-dried at 40° C. for several hours to obtain a THF-insoluble component of the toner or the like for IR analysis.

### Confirmation of Binding Between Specific Metal Element and Silicon Atom Via Oxygen Atom

The bonding between the specific metal element and the silicon atom via an oxygen atom was determined by IR analysis. As a sample, a THF-insoluble component of the toner or the like obtained by “Method for Separating THF Insoluble Component of Toner or Like for Infrared Spectroscopy (IR) Analysis” described above was used.

In the IR analysis, measurement is performed by an ATR method using a Fourier transform infrared spectroscopic analyzer (Frontier: manufactured by PerkinElmer, software: Spectrum10) equipped with a universal ATR measuring accessory (Universal ATR Sampling Accessory). Hereinafter, a case where the specific metal element is Ti will be described as an example. The absorption peak to be confirmed may be changed in accordance with the specific metal element. A specific measurement procedure is as follows.

An incident angle of infrared light (2=5 μm) is set to 45°. As an ATR crystal, an ATR crystal of Ge (refractive index=4.0) is used. Other conditions are as follows.

### Range

Start: 4000 cm⁻¹
End: 650 cm⁻¹ (ATR crystal of Ge)

### Duration

Scan number: 16
Resolution: 4.00 cm⁻¹
Advanced: with CO₂/H₂O correction
(1) An ATR crystal of Ge (refractive index=4.0) is attached to an apparatus.
(2) Scan type is set to Background, Units are set to EGY, and background is measured.
(3) Scan type is set to Sample, and Units are set to A.
(4) 0.01 g of a sample is precisely weighed and placed on the ATR crystal.
(5) The sample is pressurized with a pressure arm. (Force Gauge is 45)
(6) The sample is measured.

The absorption spectrum at 926 cm⁻¹ is confirmed. The absorption peak at 926 cm⁻¹ is caused by stretching vibration of a Ti—O—Si bond, and in a case where this peak appears, it is determined that Ti as a specific metal element and a silicon atom are bonded via an oxygen atom.

### Measurement of Moisture Adsorption Amount of Toner

In the present invention, the “moisture adsorption amount” of a toner refers to a mass based moisture content based on the Karl Fischer method, that is, a ratio of a moisture mass to a hydrous toner, and is determined by standing a toner for 72 hours (3 days) in each environment of a normal temperature and normal humidity environment (25° C./50% RH, N/N environment) and an ultrahigh temperature and high humidity environment (32.5° C./90% RH, hereinafter SH/H environment), and measuring a gas in heating at 125° C. based on the Karl Fischer method (JIS K-0068 moisture vaporization method) using a prepared sample.

### EXAMPLES

The present disclosure will be specifically described by the following Examples. However, these examples do not limit the present disclosure at all.

A toner will be described below. All “part(s)” in Examples and Comparative Examples are on a mass basis unless otherwise specified.

### Production Example of Toner Base Particle Dispersed Solution

### Production Example of Toner Base Particle Dispersed Solution 1

### Preparation of Aqueous Medium

14.0 parts of sodium phosphate (dodecahydrate) (manufactured by RASA Industries, LTD.) was added to a reaction vessel containing 385.0 parts of ion-exchanged water, and this was kept at 65° C. for 1.0 hours while being purged with nitrogen. Using T.K. Homomixer (manufactured by Tokushu Kika Kogyo Co., Ltd), a calcium chloride aqueous solution in which 9.2 parts of calcium chloride (dihydrate) was dissolved in 10.0 parts of ion-exchanged water was collectively charged into a reaction vessel with stirring at 12,000 rpm to prepare an aqueous medium containing a dispersion stabilizer.

Furthermore, 1.0 mol/L hydrochloric acid was added to the aqueous medium in the reaction vessel to adjust the pH to 6.0, thereby preparing an aqueous medium 1. The aqueous medium 1 contains phosphate ions, which are polyhydric acid ions.

### Preparation of Polymerizable Monomer Composition (Dispersion and Dissolution Step)

| | | |
|---|---|---|
| Styrene | 60.0 | parts |
| C.I. Pigment Red 122 | 6.3 | parts |
| C.I. Pigment Red 150 | 3.7 | parts |

The above materials were put into an attritor (manufactured by NIPPON COKE & ENGINEERING CO., LTD), and further dispersed at 220 rpm for 5.0 hours using zirconia particles having a diameter of 1.7 mm to prepare a colorant-dispersed solution in which a pigment was dispersed.

Then, the following materials were added to the colorant-dispersed solution.

| | | |
|---|---|---|
| Styrene | 10.0 | parts |
| n-Butyl acrylate | 30.0 | parts |
| Polyester resin | 5.0 | parts |
| (Condensation polymerization product of terephthalic acid | | |
| and 2-molar propylene oxide adduct of bisphenol A) | | |
| Fischer-Tropsch wax (melting point: 70° C.) | 7.0 | parts |

The above materials were kept at 65° C., and uniformly dissolved and dispersed at 500 rpm using T.K. Homomixer to prepare a polymerizable monomer composition.

### Granulating Step

While the temperature of the aqueous medium 1 was maintained at 70° C. and the rotation speed of a stirring device was maintained at 11,000 rpm, the polymerizable monomer composition was charged into the aqueous medium 1, and 9.0 parts of t-butyl peroxypivalate as a polymerization initiator was added thereto. Granulation was performed for 10 minutes while maintaining 11,000 rpm with a stirrer as it was.

### Polymerization Step A

The high-speed stirrer was changed to a stirrer equipped with a propeller stirring blade, and polymerization was performed for 5.0 hours while maintaining the temperature at 70° C. while stirring at 150 rpm.

### Polymerization Step B

Continuing from the polymerization step A, the temperature was further raised to 85° C. and heated for 2.0 hours to perform a polymerization reaction. Further, 0.018 parts of 3-methacryloxypropyltrimethoxysilane was added and stirred for 5 minutes, and then a 1.0 mol/L aqueous sodium hydroxide solution was added to adjust the pH to 9.0.

Further, the temperature was raised to 98° C. and heated for 3.0 hours to remove a residual monomer.

Subsequently, the temperature was lowered to 25° C., and then ion-exchanged water was added to adjust a toner base particle concentration in the dispersion to 30 mass %, thereby obtaining a toner base particle dispersed solution 1 in which the toner base particles 1 were dispersed.

The toner base particle 1 had a number-average particle diameter (D1) of 6.1 μm and a weight-average particle diameter (D4) of 6.9 μm.

Further, a part of the toner base particle dispersed solution 1 was stirred for 1 hour by adjusting the pH to 1.5 with 1.0 mol/L hydrochloric acid, and then filtered while being washed with ion-exchanged water to obtain a toner base particle 1. This was used to measure the normalized strength of silicon ions present on a toner particle surface.

### Production Example of Toner Base Particle Dispersed Solution 2

In the production example of the toner base particle dispersed solution 1, 0.360 parts of 3-methacryloxypropyltrimethoxysilane was added as a material to be added to a colorant-dispersed solution. Furthermore, 3-methacryloxypropyltrimethoxysilane was not added in “Polymerization Step B”. A toner base particle dispersed solution 2 was obtained in the same manner as in Production Example of the toner base particle dispersed solution 1 except for the above.

### Production Example of Toner Base Particle Dispersed Solution 3

In the production example of the toner base particle dispersed solution 2, the addition amount of 3-methacryloxypropyltrimethoxysilane was changed to 0.400 parts. Other than that, a toner base particle dispersed solution 3 was obtained in the same manner as in the production example of the toner base particle dispersed solution 2.

### Production Example of Toner Base Particle Dispersed Solutions 4 to 8

In the production example of the toner base particle dispersed solution 1, the addition amount of 3-methacryloxypropyltrimethoxysilane was changed as shown in Table 1.

### Production Example of Toner Base Particle Dispersed Solution 9

In the production example of the toner base particle dispersed solution 1, after the temperature was lowered to 25° C. in “Polymerization Step B”, the obtained slurry was filtered, and reslurry was performed with ion-exchanged water to remove phosphate ions from the slurry. Other than that, a toner base particle dispersed solution 9 was obtained in the same manner as in the production example of the toner base particle dispersed solution 1.

TABLE 1

| | Production method | | | |
|---|---|---|---|---|
| Toner base particle | | Number of | | |
| dispersed solution | | part(s) of | Result of analysis | |
| No. | MPTMS addition step | MPTMS added | (A) | (B) |
| Toner base particle | Polymerization step B | 1.80.E−02 | 2.51.E−03 | 5.80.E−04 |
| dispersed solution 1 | | | | |
| Toner base particle | Dispersion and | 3.60.E−01 | 2.52.E−03 | 6.99.E−04 |
| dispersed solution 2 | dissolution step | | | |
| Toner base particle | Dispersion and | 4.00.E−01 | 2.52.E−03 | 7.14.E−04 |
| dispersed solution 3 | dissolution step | | | |
| Toner base particle | Polymerization step B | 5.00.E−03 | 7.00.E−04 | 4.19.E−04 |
| dispersed solution 4 | | | | |
| Toner base particle | Polymerization step B | 4.00.E−03 | 6.78.E−04 | 4.15.E−04 |
| dispersed solution 5 | | | | |
| Toner base particle | — | 0.00E+00 | 0.00E+00 | 0.00E+00 |
| dispersed solution 6 | | | | |
| Toner base particle | Polymerization step B | 2.20.E−01 | 3.00.E−02 | 6.01.E−04 |
| dispersed solution 7 | | | | |
| Toner base particle | Polymerization step B | 2.31.E−01 | 3.15.E−02 | 6.12.E−04 |
| dispersed solution 8 | | | | |
| Toner base particle | Polymerization step B | 1.80.E−02 | 2.51.E−03 | 5.80.E−04 |
| dispersed solution 9 | | | | |

In the table, for example, 1.80. E-02 indicates 1.80×10⁻².

In Table 1, reference signs (A) and (B) represent the following contents.
(A) Normalized strength of silicon Ions (m/z=28) according to time-of-flight secondary ion mass spectrometer (TOFSIMS) derived from condensation product of organosilicon compounds of toner base particles
(B) Normalized strength of silicon ions (m/z=28) after sputtering under the condition (A)

### Production Example of Organosilicon Compound Liquid

### Production Example of Organosilicon Compound Liquid 1

| | |
|---|---|
| Ion-exchanged water | 70.0 parts |
| Methyltriethoxysilane | 30.0 parts |

The material was weighed into a 200 ml beaker and the pH was adjusted to 3.5 with 10% hydrochloric acid. Thereafter, the mixture was stirred for 1.0 hours while the temperature was adjusted to 30° C. with a water bath to prepare an organosilicon compound liquid 1.

### Production Example of Toner Particle

### Production Example of Toner Particle 1

330.0 parts of the toner base particle dispersed solution 1 was weighed into a reaction vessel, and stirred using a propeller stirring blade.

Next, 1.0 mol/L hydrochloric acid was added to adjust the pH of the mixed solution to 5.5, and then 5.5 parts of an organosilicon compound liquid 1 was added thereto. Thereafter, 0.50 parts (TC-315: manufactured by Matsumoto Fine Chemical Co., Ltd., corresponding to 0.22 parts as titanium lactate) of a 44% aqueous titanium lactate solution was added.

Next, the temperature of the mixed solution was set to 55° C., and then the pH was adjusted to 9.5 using a 1.0 mol/L NaOH aqueous solution over 15 minutes. Thereafter, while mixing using a propeller stirring blade, the temperature was maintained at 55° C. for 3 hours.

After the temperature was lowered to 25° C., the pH was adjusted to 1.5 with 1.0 mol/L hydrochloric acid, the mixture was stirred for 1 hour, and then filtered while being washed with ion-exchanged water, thereby obtaining a toner particle 1. This was defined as a toner 1.

As a result of the analysis, it was confirmed that the toner 1 had a silicon polymer composite containing an organosilicon polymer and a titanium atom on the surface of the toner base particle, and the silicon polymer composite fixed to the surface of the toner base particle in a protrusion shape. Further, (ME/SiE)/MX was confirmed to be 1.53, and MX was confirmed to be 0.013. In addition, as a result of analysis of a bonding state by infrared spectroscopy, it was confirmed that a silicon atom and a titanium atom were partially bonded via an oxygen atom.

### Preparation Examples of Toner Particles 2 to 12, 18 to 30, and 33

In the production example of the toner particle 1, the toner base particle dispersed solution to be used and the production conditions were changed as shown in Table 2-1. Other than that, toner particles 2 to 12, 18 to 30, and 33 were obtained in the same manner as in the production examples of the toner particle 1. The metal lactate used in toners 10 to 12 is as follows.
Zr: Zirconium lactate ammonium salt (Matsumoto Fine Chemical Co., Ltd)
Cu: Copper (II) lactate (n-hydrate) (Mitsuwa Chemicals Co., Ltd)
Al: Aluminum L-lactate (Sigma-Aldrich)

### Production Example of Toner Particle 13

330.0 parts of the toner base particle dispersed solution 1 was weighed into a reaction vessel, and stirred using a propeller stirring blade.

Next, immediately after 1.0 mol/L hydrochloric acid was added to adjust the pH of the mixed solution to 5.5, 0.50 parts (TC-315: manufactured by Matsumoto Fine Chemical Co., Ltd., corresponding to 0.22 parts as titanium lactate) of a 44% aqueous titanium lactate solution was added.

Next, the temperature of the mixed solution was set to 55° C., and then the pH was rapidly adjusted to 9.5 using a 1.0 mol/L NaOH aqueous solution. Thereafter, while mixing using a propeller stirring blade, the temperature was maintained at 55° C. for 1 hour.

Next, 1.0 mol/L hydrochloric acid was added to adjust the pH of the mixed solution to 5.5, and then 5.5 parts of an organosilicon compound liquid 1 was added thereto. Thereafter, the pH was adjusted to 9.5 using a 1.0 mol/L NaOH aqueous solution over 15 minutes.

Thereafter, while mixing using a propeller stirring blade, the temperature was maintained at 55° C. for 3 hours. After the temperature was lowered to 25° C., the pH was adjusted to 1.5 with 1.0 mol/L hydrochloric acid, the mixture was stirred for 1 hour, and then filtered while being washed with ion-exchanged water, thereby obtaining a toner particle 13. This was defined as a toner 13. As a result of analysis of a bonding state by infrared spectroscopy, it was confirmed that a silicon atom and a titanium atom were not partially bonded via an oxygen atom. It is considered that the titanium lactate reacted with the phosphate ion before the silane coupling was added to form titanium phosphate, and the reaction was completed.

### Production Example of Toner Particle 14

In the production example of the toner particle 1, after 1 hour when the pH was adjusted to 9.5, 0.20 parts of the organosilicon compound liquid 1 was further added. In addition, the manufacturing conditions were changed as shown in Table 2-1. Other than that, a toner particle 14 was obtained in the same manner as in the production example of the toner particle 1.

### Production Example of Toner Particle 15

In the production example of the toner particle 14, the amount of the organosilicon compound liquid 1 further added was 0.40 parts. In addition, the manufacturing conditions were changed as shown in Table 2-1. Other than that, a toner particle 15 was obtained in the same manner as in the production example of the toner particle 14.

### Production Example of Toner Particle 16

In Production Example of toner particle 1, 1 hour after the pH was adjusted to 9.5, separately from the previously added titanium lactate, an aqueous copper lactate solution was charged so that the copper lactate was 0.02 parts. Other than that, a toner particle 16 was obtained in the same manner as in the production example of the toner 1. Here, the copper lactate is added for the purpose of partially coating the surface of the silicon polymer composite.

### Production Example of Toner Particle 17

In the production example of the toner particle 16, an aqueous copper lactate solution was charged so that the amount of copper lactate was 0.03 parts. Other than that, a toner particle 17 was obtained in the same manner as in the production example of the toner particle 16. Here, the copper lactate is added for the purpose of partially coating the surface of the silicon polymer composite.

### Production Example of Toner Particle 31

### Protrusion Forming Step

The following samples were weighed into a reaction vessel and mixed using a propeller stirring blade.

| | | |
|---|---|---|
| Toner base particle dispersed solution 1 | 330.0 | parts |
| Organosilicon compound liquid 1 | 4.5 | parts |

Next, the pH of the resulting mixed solution was adjusted to 6.0 using a 1 mol/L NaOH aqueous solution, the temperature of the mixed solution was set to 50° C., and then the mixed solution was kept for 1.0 hours while being mixed using a propeller stirring blade (Protrusion forming step 1).

Thereafter, the pH of the mixed solution was adjusted to 9.5 using a 1 mol/L NaOH aqueous solution and kept for 1.0 hours (Protrusion forming step 2).

### Polyhydric Acid Metal Salt Attaching Step

| | |
|---|---|
| 44% Aqueous solution of titanium | 0.50 parts (corresponding to |
| lactate (TC-310: manufactured by | 0.22 parts as titanium lactate) |
| Matsumoto Fine Chemical Co., Ltd) | |
| Organosilicon compound liquid 1 | 1.0 part |

Subsequently, the sample was weighed and mixed in a reaction vessel, and then the pH of the resulting mixed solution was adjusted to 9.5 using a 1 mol/L NaOH aqueous solution and kept for 4.0 hours. After the temperature was lowered to 25° C., the pH was adjusted to 1.5 with 1 mol/L hydrochloric acid, the mixture was stirred for 1.0 hour, and then filtered while being washed with ion-exchanged water, thereby obtaining a toner particle 31.

As a result of observing the cross section of the toner particle 31, a protruded portion containing an organosilicon polymer and a polyhydric acid metal salt was observed on the surface of the toner base particle, and it was confirmed that titanium was present on the surface of the protruded portion. Therefore, the organosilicon polymer composite was present.

In addition, it was confirmed that titanium was not present inside the protruded portion formed of the organosilicon polymer.

Furthermore, as a result of analysis of a bonding state by infrared spectroscopy, it was confirmed that a silicon atom and a titanium atom were not partially bonded via an oxygen atom.

### Production Example of Toner Particle 32

The following samples were weighed into a reaction vessel and mixed using a propeller stirring blade.

| | | |
|---|---|---|
| Toner base particle dispersed solution 1 | 330.0 | parts |
| Organosilicon compound liquid 1 | 1.0 | part |

| | |
|---|---|
| 44% Aqueous solution of titanium | 0.46 parts (corresponding to |
| lactate (TC-310: manufactured by | 0.20 parts as titanium lactate) |
| Matsumoto Fine Chemical Co., Ltd) | |

Next, the pH of the resulting mixed solution was adjusted to 7.0 using a 1 mol/L NaOH aqueous solution, the temperature of the mixed solution was set to 50° C., and then the mixed solution was kept for 1.0 hours while being mixed using a propeller stirring blade. Thereafter, the pH was adjusted to 9.5 using a 1 mol/L aqueous NaOH solution, and the temperature was 50° C. and kept for 2.0 hours with stirring.

1.0 mol/L of hydrochloric acid was added with stirring using a propeller stirring blade to adjust the pH of the mixed solution to 7.0. The following samples were weighed in a reaction vessel, mixed, and then kept for 1.0 hours.

| | |
|---|---|
| Organosilicon compound liquid 1 | 4.5 parts |

The pH was adjusted to 9.5 using a 1 mol/L aqueous NaOH solution, and the temperature was 50° C. and kept for 2.0 hours with stirring. After the temperature was lowered to 25° C., the pH was adjusted to 1.5 with 1 mol/L hydrochloric acid, the mixture was stirred for 1.0 hour, and then filtered while being washed with ion-exchanged water, thereby obtaining a toner particle 32 in which a part of the titanium phosphate compound on the surface of the toner base particle 1 was covered with the protruded portion formed of the organosilicon polymer.

As a result of analysis of a bonding state by infrared spectroscopy, it was confirmed that a silicon atom and a titanium atom were not partially bonded via an oxygen atom. This is considered to be because titanium lactate reacted with phosphate ions to form titanium phosphate before charging a large amount of the organosilicon compound liquid 1 in a second stage, and the reaction was terminated.

### Production Example of Toner Particle 34

The toner base particle dispersed solution 1 was stirred for 1 hour by adjusting the pH to 1.5 with 1.0 mol/L hydrochloric acid, and then filtered while being washed with ion-exchanged water and dried, and the extracted toner base particle 1 was used as it was as the toner particle 34.

### Production Example of Toner

### Production Example of Toners 1 to 25

The toner particles 1 to 25 were designated as toners 1 to 25, respectively.

### Production Example of Comparative Toners 1 to 8

The toner particles 26 to 33 were designated as comparative toners 1 to 8, respectively.

### Production Example of Comparative Toner 9

| | | |
|---|---|---|
| Toner particle 34 | 100.0 | parts |
| Titanium oxide particles | 0.028 | parts |
| (volume-average particle diameter: 23 nm) | | |
| Hydrophobic silica microparticles which are | 1.00 | part |
| surface-treated with dimethyl silicone oil | | |
| (volume-average particle diameter | | |
| of primary particles: 7 nm) | | |

The above materials were charged into SUPERMIXER PICCOLO SMP-2 (manufactured by Kawata Corporation), and were mixed at 3,000 rpm for 20 minutes. Thereafter, sieving was performed with a mesh having an opening of 150 μm to obtain a comparative toner 9.

### Production Example of Comparative Toner 10

A comparative toner 10 was obtained in the same manner as in the production example of the comparative toner 9 except that the addition amount of the titanium oxide particles was changed to 0.34 parts in the production example of the comparative toner 9.

The configurations and physical properties of the toners 1 to 25 and the comparative toners 1 to 10 are shown in Tables 2-1 and 2-2.

TABLE 2-1

| Toner base particle | Toner | Toner | Production method | | | | | |
|---|---|---|---|---|---|---|---|---|
| dispersed solution No. | particle No | No. | (A) | (B) | (C) | (D) | (E) | (F) |
| Toner base particle | Toner particle 1 | Toner 1 | 5.5 | 0.50 | 0.22 | 15 | 55 | 9.5 |
| dispersed solution 1 | | | | | | | | |
| Toner base particle | Toner particle 2 | Toner 2 | 5.5 | 0.50 | 0.22 | 15 | 55 | 9.5 |
| dispersed solution 2 | | | | | | | | |
| Toner base particle | Toner particle 3 | Toner 3 | 5.5 | 0.46 | 0.20 | 15 | 55 | 9.5 |
| dispersed solution 3 | | | | | | | | |
| Toner base particle | Toner particle 4 | Toner 4 | 5.5 | 0.46 | 0.20 | 15 | 55 | 9.5 |
| dispersed solution 4 | | | | | | | | |
| Toner base particle | Toner particle 5 | Toner 5 | 5.5 | 0.54 | 0.24 | 15 | 55 | 9.5 |
| dispersed solution 5 | | | | | | | | |
| Toner base particle | Toner particle 6 | Toner 6 | 5.5 | 0.57 | 0.25 | 15 | 55 | 9.5 |
| dispersed solution 6 | | | | | | | | |
| Toner base particle | Toner particle 7 | Toner 7 | 5.5 | 0.54 | 0.24 | 15 | 55 | 9.5 |
| dispersed solution 7 | | | | | | | | |
| Toner base particle | Toner particle 8 | Toner 8 | 5.5 | 0.46 | 0.20 | 15 | 55 | 9.5 |
| dispersed solution 8 | | | | | | | | |
| Toner base particle | Toner particle 9 | Toner 9 | 5.5 | 0.46 | 0.20 | 15 | 55 | 9.5 |
| dispersed solution 9 | | | | | | | | |
| Toner base particle | Toner particle 10 | Toner 10 | 5.5 | 0.46 | 0.20 | 15 | 55 | 9.5 |
| dispersed solution 1 | | | | | | | | |
| Toner base particle | Toner particle 11 | Toner 11 | 5.5 | 0.46 | 0.20 | 15 | 55 | 9.5 |
| dispersed solution 1 | | | | | | | | |
| Toner base particle | Toner particle 12 | Toner 12 | 5.5 | 0.46 | 0.20 | 15 | 55 | 9.5 |
| dispersed solution 1 | | | | | | | | |
| Toner base particle | Toner particle 13 | Toner 13 | 5.5 | 0.50 | 0.22 | 15 | 55 | 9.5 |
| dispersed solution 1 | | | | | | | | |
| Toner base particle | Toner particle 14 | Toner 14 | 5.7 | 0.44 | 0.19 | 15 | 55 | 9.5 |
| dispersed solution 1 | | | | | | | | |
| Toner base particle | Toner particle 15 | Toner 15 | 5.9 | 0.49 | 0.22 | 15 | 55 | 9.5 |
| dispersed solution 1 | | | | | | | | |
| Toner base particle | Toner particle 16 | Toner 16 | 5.5 | 1.68 | 0.74 | 15 | 55 | 9.5 |
| dispersed solution 1 | | | | | | | | |
| Toner base particle | Toner particle 17 | Toner 17 | 5.5 | 1.80 | 0.79 | 15 | 55 | 9.5 |
| dispersed solution 1 | | | | | | | | |
| Toner base particle | Toner particle 18 | Toner 18 | 5.5 | 0.42 | 0.19 | 15 | 40 | 9.5 |
| dispersed solution 1 | | | | | | | | |
| Taner base particle | Toner particle 19 | Toner 19 | 5.5 | 0.46 | 0.20 | 15 | 35 | 9.5 |
| dispersed solution 1 | | | | | | | | |
| Toner base particle | Toner particle 20 | Taner 20 | 3.0 | 0.27 | 0.12 | 60 | 55 | 9.5 |
| dispersed solution 1 | | | | | | | | |
| Toner base particle | Toner particle 21 | Toner 21 | 5.5 | 0.38 | 0.17 | 15 | 55 | 9.5 |
| dispersed solution 1 | | | | | | | | |
| Toner base particle | Toner particle 22 | Toner 22 | 5.5 | 0.19 | 0.08 | 15 | 55 | 9.5 |
| dispersed solution 1 | | | | | | | | |
| Toner base particle | Toner particle 23 | Toner 23 | 5.5 | 2.30 | 1.01 | 15 | 55 | 9.5 |
| dispersed solution 1 | | | | | | | | |
| Toner base particle | Toner particle 24 | Toner 24 | 5.5 | 0.42 | 0.19 | 15 | 55 | 8.5 |
| dispersed solution 1 | | | | | | | | |
| Toner base particle | Toner particle 25 | Toner 25 | 5.5 | 0.61 | 0.27 | 15 | 55 | 10.5 |
| dispersed solution 1 | | | | | | | | |
| Toner base particle | Toner particle 26 | Comparative | 5.5 | 0.16 | 0.07 | 15 | 55 | 9.5 |
| dispersed solution 1 | | toner 1 | | | | | | |
| Toner base particle | Toner particle 27 | Comparative | 5.5 | 2.49 | 1.10 | 16 | 55 | 9.5 |
| dispersed solution 1 | | toner 2 | | | | | | |
| Toner base particle | Toner particle 28 | Comparative | 5.5 | 0.31 | 0.13 | 15 | 55 | 8.0 |
| dispersed solution 1 | | toner 3 | | | | | | |
| Toner base particle | Toner particle 29 | Comparative | 5.5 | 1.00 | 0.44 | 15 | 55 | 11.0 |
| dispersed solution 1 | | toner 4 | | | | | | |
| Toner base particle | Toner particle 30 | Comparative | 0.0 | 0.50 | 0.22 | — | 55 | 9.5 |
| dispersed solution 1 | | toner 5 | | | | | | |
| Toner base particle | Toner particle 31 | Comparative | 5.5 | 0.50 | 0.22 | 0.1 | 50 | 9.5 |
| dispersed solution 1 | | toner 6 | | | | | | |
| Toner base particle | Toner particle 32 | Comparative | 5.5 | 0.46 | 0.20 | 0.1 | 50 | 7.0 |
| dispersed solution 1 | | toner 7 | | | | | | |
| Toner base particle | Toner particle 33 | Comparative | 5.5 | — | — | 15 | 55 | 9.5 |
| dispersed solution 1 | | toner 8 | | | | | | |
| Toner base particle | Toner particle 34 | Comparative | — | — | — | — | — | — |
| dispersed solution 1 | | toner 9 | | | | | | |
| Toner base particle | Toner particle 34 | Comparative | — | — | — | — | — | — |
| dispersed solution 1 | | toner 10 | | | | | | |

Reference signs (A) to (F) in Table 2-1 represent the following contents.
(A) Amount of organosilicon compound liquid (parts)
(B) Amount of metal lactate aqueous solution (parts)
(C) Amount of metal lactate (parts)
(D) NaOH addition time (min) after addition of organosilicon compound liquid
(E) Temperature of mixture (° C.)
(F) pH of mixture

TABLE 2-2

| Toner | Toner | Result of analysis | | | | | | | | |
|---|---|---|---|---|---|---|---|---|---|---|
| No. | particle No. | (G) | (H) | (I) | (J) | (K) | (L) | (M) | (N) | (O) |
| 1 | Toner particle 1 | Presence | Ti | 1.53 | 1.3E−02 | Presence | 1.35 | 5.6E−04 | Presence | Presence |
| 2 | Toner particle 2 | Presence | Ti | 1.52 | 1.3E−02 | Presence | 1.37 | 5.3E−04 | Presence | Presence |
| 3 | Toner particle 3 | Presence | Ti | 1.52 | 1.2E−02 | Presence | 1.36 | 5.3E−04 | Presence | Presence |
| 4 | Toner particle 4 | Presence | Ti | 1.53 | 1.2E−02 | Presence | 1.36 | 5.4E−04 | Presence | Presence |
| 5 | Toner particle 5 | Presence | Ti | 1.54 | 1.4E−02 | Presence | 1.33 | 5.8E−04 | Presence | Presence |
| 6 | Toner particle 6 | Presence | Ti | 1.53 | 1.5E−02 | Presence | 1.34 | 5.9E−04 | Presence | Presence |
| 7 | Toner particle 7 | Presence | Ti | 1.54 | 1.4E−02 | Presence | 1.36 | 5.9E−04 | Presence | Presence |
| 8 | Toner particle 8 | Presence | Ti | 1.52 | 1.2E−02 | Presence | 1.37 | 5.3E−04 | Presence | Presence |
| 9 | Toner particle 9 | Presence | Ti | 1.52 | 1.2E−02 | Presence | 1.36 | 5.3E−04 | Presence | Absence |
| 10 | Toner particle 10 | Presence | Zr | 1.51 | 1.2E−02 | Presence | 1.38 | 5.1E−04 | Presence | Presence |
| 11 | Toner particle 11 | Presence | Cu | 1.52 | 1.2E−02 | Presence | 1.36 | 5.3E−04 | Presence | Presence |
| 12 | Toner particle 12 | Presence | Al | 1.51 | 1.2E−02 | Presence | 1.38 | 5.1E−04 | Presence | Presence |
| 13 | Toner particle 13 | Presence | Ti | 1.52 | 1.3E−02 | Presence | 1.36 | 5.3E−04 | Absence | Presence |
| 14 | Toner particle 14 | Presence | Ti | 0.77 | 1.1E−02 | Presence | 1.60 | 1.0E−05 | Presence | Presence |
| 15 | Toner particle 15 | Presence | Ti | 0.70 | 1.2E−02 | Presence | 1.63 | 8.5E−06 | Presence | Presence |
| 16 | Toner particle 16 | Presence | Ti | 1.85 | 4.4E−02 | Presence | 1.12 | 1.0E−02 | Presence | Presence |
| 17 | Toner particle 17 | Presence | Ti | 1.88 | 4.7E−02 | Presence | 1.10 | 1.2E−02 | Presence | Presence |
| 18 | Toner particle 18 | Presence | Ti | 0.81 | 1.1E−02 | Presence | 1.75 | 3.9E−05 | Presence | Presence |
| 19 | Toner particle 19 | Presence | Ti | 0.70 | 1.2E−02 | Presence | 1.82 | 2.5E−05 | Presence | Presence |
| 20 | Toner particle 20 | Presence | Ti | 1.52 | 1.3E−02 | Film | 1.45 | 5.7E−04 | Presence | Presence |
| 21 | Toner particle 21 | Presence | Ti | 1.22 | 1.0E−02 | Presence | 1.42 | 2.4E−04 | Presence | Presence |
| 22 | Toner particle 22 | Presence | Ti | 1.13 | 5.0E−03 | Presence | 1.44 | 1.9E−04 | Presence | Presence |
| 23 | Toner particle 23 | Presence | Ti | 2.23 | 6.0E−02 | Presence | 1.16 | 5.4E−03 | Presence | Presence |
| 24 | Toner particle 24 | Presence | Ti | 0.50 | 1.1E−02 | Presence | 1.46 | 1.7E−04 | Presence | Presence |
| 25 | Toner particle 25 | Presence | Ti | 2.50 | 1.6E−02 | Presence | 1.28 | 9.7E−04 | Presence | Presence |
| Comparison 1 | Toner particle 26 | Presence | Ti | 0.75 | 4.3E−03 | Presence | 1.48 | 2.7E−05 | Presence | Presence |
| Comparison 2 | Toner particle 27 | Presence | Ti | 2.45 | 6.5E−02 | Presence | 1.13 | 9.0E−03 | Presence | Presence |
| Comparison 3 | Toner particle 28 | Presence | Ti | 0.38 | 8.0E−03 | Presence | 1.70 | 8.5E−06 | Presence | Presence |
| Comparison 4 | Toner particle 29 | Presence | Ti | 2.70 | 2.6E−02 | Presence | 1.10 | 1.4E−02 | Presence | Presence |
| Comparison 5 | Toner particle 30 | Absence | — | — | — | — | — | 8.0E−04 | Absence | Presence |
| Comparison 6 | Toner particle 31 | Presence | — | 2.61 | 1.3E−02 | Presence | 1.05 | 3.4E−03 | Absence | Presence |
| Comparison 7 | Toner particle 32 | Presence | — | 2.52 | 1.2E−02 | Presence | 1.04 | 2.6E−03 | Absence | Presence |
| Comparison 8 | Toner particle 33 | Absence | — | — | — | — | — | — | — | Absence |
| Comparison 9 | Toner particle 34 | — | — | 2.59 | 5.1E−03 | — | — | — | — | Absence |
| Comparison 10 | Toner particle 34 | — | — | 2.82 | 6.3E−02 | — | — | — | — | Absence |

Reference signs (G) to (O) in Table 2-2 represent the following contents.
(G) Silicon polymer composite
(H) Kind of metal atom contained in silicon polymer composite
(I) Metal atom exposure ratio; (ME/SiE)/MX
(J) Amount of metal atom relative to amount of silicon atom; MX
(K) Presence or absence of protrusion shape of silicon polymer composite. The word “film” indicates that the silicon polymer composite has not a protrusion shape but a film shape.
(L) Metal atom dispersion index; Mmax/Mave
(M) Conductivity (S/m) of silicon polymer composite measured at frequency of 10 kHz
(N) Presence or absence of M-O—Si bond (M is a specific metal element)
(O) Presence or absence of polyhydric acid metal salt on surface of toner particle

### Examples 1 to 25 and Comparative Examples 1 to 10

Evaluation was performed by the following method using the toners 1 to 25 and the comparative toners 1 to 10. The evaluation results are shown in Table 3.

Hereinafter, an evaluation method and evaluation criteria will be described.

### Evaluation Machine

As an image forming apparatus, a modified machine in which LBP-712Ci (manufactured by Canon Inc), which is a commercially available laser printer, was connected to an external high-voltage power source, and modified so that a predetermined potential difference was provided between a charging blade and a charging roller, and the process speed was set to 270 mm/see was used. Furthermore, a toner cartridge 040H (magenta) (manufactured by Canon Inc), which is a commercially available process cartridge, was used.

A product toner was removed from an inside of the cartridge, cleaned by air blowing, and then the cartridge was filled with 165 g of the toner to be evaluated. Product toner was removed from each of the yellow, cyan, and black stations, and yellow, cyan, and black cartridges in which the toner remaining amount detection mechanism was disabled were inserted and evaluated.

### Evaluation of Fogging

First, the main body and the cartridge were left in an ultra-high temperature and high humidity environment (32.5° C./90% RH, hereinafter SH/H environment) for 5 days. After being left to stand, the following evaluations were performed.

As development conditions, a voltage of a charging blade was set to −500 V, and a voltage of the developing roller was set to −300 V. Under the SH/H environment, a print-out test for 30,000 sheets in total was performed by repeating the intermittent operation of temporarily stopping every time 2 images having a print percentage of 1% were output. After completion of the print-out test, a solid white image was output, and a reflectance (%) of the solid white image was measured by REFLECTOMETER MODEL TC-6DS (manufactured by Tokyo Denshoku Co., Ltd).

Evaluation was performed using a numerical value (%) obtained by subtracting the obtained reflectance from a reflectance (%) of an unused printout sheet (standard gloss paper) measured in the same manner. As the numerical value is smaller, image fogging is suppressed. The solid white image was output using glossy paper (HP Brochure Paper 200 g, Glossy, manufactured by HP, 200 g/m²) in a glossy paper mode. The evaluation was performed at the initial stage before printing out the 30,000 sheets and after printing out. A level of C or higher was determined to be a favorable level.

In a toner having excellent charging performance, a favorable image with less fogging can be obtained.

In a toner having excellent environmental stability and low hygroscopicity of a surface layer, favorable charging performance is exhibited even in a high humidity environment. Then, a toner with less fogging can increase the number of printable sheets of a toner cartridge by suppressing a toner consumption amount at the time of long-term use.

### Evaluation Criteria

A: Subtracted value is less than 0.4%
B: Subtracted value is 0.4% or more and less than 0.8%
C: Subtracted value is 0.8% or more and less than 1.3%
D: Subtracted value is 1.3% or more.

Furthermore, the above-described evaluation of fogging was also performed under a low temperature and low humidity environment (15° C./10% RH, hereinafter, LL environment).

Further, the evaluation was performed under a high temperature and high humidity environment (32.5° C., humidity 80% RH, hereinafter H/H environment) while the process speed was changed to 230 mm/sec.

### Solid Followability

As development conditions, a voltage of a charging blade was set to −500 V, and a voltage of the developing roller was set to −300 V. Using a modified machine of the process cartridge and the laser printer, full solid images were output on 5 sheets of LETTER sized Business 4200 paper (75 g/m², manufactured by XEROX Corporation) under an SH/H environment.

Solid followability was evaluated for the obtained full solid image.

The image density was measured by measuring a relative density with respect to an image of a white portion having an image density of 0.00, using “Macbeth reflection densitometer RD 918” (manufactured by Macbeth) according to the attached instruction manual, and the obtained relative density was taken as a value of the image density. Note that, a level of C or higher was determined to be a favorable level.

### Evaluation Criteria of Solid Followability

Evaluation was performed using a difference between an image density at a leading end of a first full solid image and an image density at a trailing end of a third full solid image.
A: Difference between an image density at a leading end of a first full solid image and an image density at a trailing end of a third full solid image is less than 0.10.
B: Difference between an image density at a leading end of a first full solid image and an image density at a trailing end of a third full solid image is 0.10 or more and less than 0.20.
C: Difference between an image density at a leading end of a first full solid image and an image density at a trailing end of a third full solid image is 0.20 or more and less than 0.30.
D: Difference between an image density at a leading end of a first full solid image and an image density at a trailing end of a third full solid image is 0.30 or more.

### Evaluation of Transfer Efficiency

The transfer efficiency is an index of transferability indicating a percentage of toner developed on a photosensitive drum transferred onto an intermediate transfer belt. As development conditions, a voltage of a charging blade was set to −500 V, and a voltage of the developing roller was set to −300 V. The evaluation of the transfer efficiency was performed by forming a full solid image on a recording medium by using the modified machine of the laser printer (process speed; 270 mm/sec) and LETTER sized Business 4200 paper (75 g/m², manufactured by XEROX Corporation). A primary transfer bias of the modified machine of the laser printer was set to a potential at which a potential difference was 100 V smaller than a normal potential, and a full solid image was output in an ultra-high temperature and high humidity environment (32.5° C./90% RH, SH/H environment). Thereafter, a toner transferred onto an intermediate transfer belt and a toner remaining on a photosensitive drum after the transfer were removed with a transparent polyester adhesive tape.

A density difference was calculated by subtracting a density of only the adhesive tape attached on the paper from a toner density of the adhesive tape peeled off and attached on the paper. The transfer efficiency is a ratio of the toner density difference on the intermediate transfer belt in a case where the sum of the respective toner density differences is 100, and the higher the ratio is, the better the transfer efficiency is. In the evaluation of the transfer efficiency, the following criteria was used for determination. Note that, a level of C or higher was determined to be a favorable level.

The toner density was measured with an X-Rite color reflection densitometer (500 series).
A: Transfer efficiency is 98% or more
B: Transfer efficiency is 95% or more and less than 98%
C: Transfer efficiency is 90% or more and less than 95%
D: Transfer efficiency is less than 90%

### Evaluation of Moisture Adsorption Amount

The moisture adsorption amount was determined by the method described above, and a difference between the NN environment and the SHH environment was determined.

TABLE 3

| | | | | | Fogging in SHH | | | | Fogging in WH | |
|---|---|---|---|---|---|---|---|---|---|---|
| | | Moisture adsorption | | | Initial stage | | | | Initial stage | |
| | | amount after being left | | | (first sheet) | | 30,000 sheets | | (first sheet) | |
| | | for 3 days (mass %) | | | Numerical | | Numerical | | Numerical | |
| Example No. | Toner No. | NN | SHH | Difference | value | Rank | value | Rank | value | Rank |
| Example 1 | Toner 1 | 0.28 | 0.35 | 0.07 | 0.3 | A | 0.1 | A | 0.1 | A |
| Example 2 | Toner 2 | 0.32 | 0.42 | 0.10 | 0.2 | A | 0.2 | A | 0.1 | A |
| Example 3 | Toner 3 | 0.32 | 0.44 | 0.12 | 0.2 | A | 0.2 | A | 0.1 | A |
| Example 4 | Toner 4 | 0.31 | 0.41 | 0.10 | 0.2 | A | 0.2 | A | 0.1 | A |
| Example 5 | Toner 5 | 0.31 | 0.42 | 0.11 | 0.3 | A | 0.3 | A | 0.1 | A |
| Example 6 | Toner 6 | 0.31 | 0.43 | 0.12 | 0.4 | B | 0.4 | B | 0.1 | A |
| Example 7 | Toner 7 | 0.31 | 0.40 | 0.09 | 0.2 | A | 0.2 | A | 0.1 | 4 |
| Example 8 | Toner 8 | 0.32 | 3.42 | 0.10 | 0.3 | A | 0.3 | A | 0.1 | A |
| Example 9 | Toner 9 | 0.31 | 0.42 | 0.11 | 0.2 | A | 0.2 | A | 0.1 | A |
| Example 10 | Toner 10 | 0.35 | 0.52 | 0.17 | 0.2 | A | 0.4 | B | 0.1 | A |
| Example 11 | Toner 11 | 0.35 | 0.53 | 0.18 | 0.2 | A | 0.4 | B | 0.1 | A |
| Example 12 | Toner 12 | 0.36 | 0.55 | 0.19 | 0.2 | A | 0.4 | B | 0.1 | A |
| Example 13 | Toner 13 | 0.32 | 0.42 | 0.10 | 0.3 | A | 0.3 | A | 0.1 | A |
| Example 14 | Toner 14 | 0.32 | 0.41 | 0.09 | 0.3 | A | 0.3 | A | 0.1 | A |
| Example 15 | Toner 15 | 0.33 | 0.42 | 0.09 | 0.4 | B | 0.4 | B | 0.1 | A |
| Example 16 | Toner 16 | 0.32 | 0.42 | 0.10 | 0.2 | A | 0.2 | A | 0.1 | A |
| Example 17 | Toner 17 | 0.33 | 0.43 | 0.10 | 0.3 | A | 0.3 | A | 0.1 | A |
| Example 18 | Toner 18 | 0.31 | 0.41 | 0.10 | 0.3 | A | 0.3 | A | 0.1 | A |
| Example 19 | Toner 19 | 0.32 | 0.42 | 0.10 | 0.4 | B | 0.4 | B | 0.1 | A |
| Example 20 | Toner 20 | 0.35 | 0.54 | 0.19 | 0.4 | B | 0.4 | B | 0.1 | A |
| Example 21 | Toner 21 | 0.33 | 0.43 | 0.10 | 0.2 | A | 0.2 | A | 0.1 | A |
| Example 22 | Toner 22 | 0.31 | 0.42 | 0.11 | 0.3 | A | 0.3 | A | 0.1 | A |
| Example 23 | Toner 23 | 0.40 | 0.74 | 0.34 | 0.4 | B | 0.6 | B | 0.2 | 4 |
| Example 24 | Toner 24 | 0.31 | 0.43 | 0.12 | 0.3 | A | 0.3 | A | 0.1 | A |
| Example 25 | Toner 25 | 0.41 | 0.77 | 0.36 | 0.4 | B | 0.6 | B | 0.2 | A |
| Comparative | Comparative | 0.32 | 0.44 | 0.12 | 1.6 | D | 1.7 | D | 0.3 | A |
| Example 1 | Toner 1 | | | | | | | | | |
| Comparative | Comparative | 0.46 | 0.89 | 0.43 | 1.5 | D | 1.6 | D | 0.1 | A |
| Example 2 | Toner 2 | | | | | | | | | |
| Comparative | Comparative | 0.32 | 0.43 | 0.11 | 0.8 | C | 0.8 | C | 0.3 | A |
| Example 3 | Toner 3 | | | | | | | | | |
| Comparative | Comparative | 0.46 | 0.91 | 0.45 | 1.5 | D | 1.6 | D | 0.1 | A |
| Example 4 | Toner 4 | | | | | | | | | |
| Comparative | Comparative | 0.50 | 1.13 | 0.63 | 1.7 | D | 2.0 | D | 0.1 | A |
| Example 5 | Toner 5 | | | | | | | | | |
| Comparative | Comparative | 0.52 | 1.14 | 0.62 | 1.7 | D | 2.0 | D | 0.1 | A |
| Example 6 | Toner 6 | | | | | | | | | |
| Comparative | Comparative | 0.55 | 1.18 | 0.63 | 1.6 | D | 1.9 | D | 0.1 | A |
| Example 7 | Toner 7 | | | | | | | | | |
| Comparative | Comparative | 0.31 | 0.42 | 0.11 | 1.5 | D | 1.8 | D | 0.3 | A |
| Example 8 | Toner 8 | | | | | | | | | |
| Comparative | Comparative | 0.31 | 0.41 | 0.10 | 2.0 | D | 2.1 | D | 0.9 | C |
| Example 9 | Toner 9 | | | | | | | | | |
| Comparative | Comparative | 0.65 | 1.36 | 0.71 | 2.0 | D | 2.2 | D | 1.0 | C |
| Example 10 | Toner 10 | | | | | | | | | |

| | | | | | | | Solid image | | Transfer | |
|---|---|---|---|---|---|---|---|---|---|---|
| | | | Fogging in UL | | | | followability | | efficiency | |
| | Fogging in WH | | Initial stage | | | | Initial | | Initial | |
| | 30,000 sheets | | (first sheet) | | 30,000 sheets | | stage | | stage | |
| | Numerical | | Numerical | | Numerical | | (first | | (first | |
| Example No. | value | Rank | valve | Rank | value | Rank | sheet) | Rank | sheet) | Rank |
| Example 1 | 0.1 | A | 0.1 | A | 0.1 | A | 0.02 | A | 99 | A |
| Example 2 | 0.1 | A | 0.1 | A | 0.1 | A | 0.04 | A | 98 | A |
| Example 3 | 0.1 | A | 0.1 | A | 0.1 | A | 0.06 | A | 96 | B |
| Example 4 | 0.1 | A | 0.1 | A | 0.1 | A | 0.04 | A | 99 | A |
| Example 5 | 0.1 | A | 0.1 | A | 0.1 | A | 0.05 | A | 99 | A |
| Example 6 | 0.1 | A | 0.1 | A | 0.1 | A | 0.06 | A | 99 | A |
| Example 7 | 0.1 | A | 0.1 | A | 0.1 | A | 0.04 | A | 96 | B |
| Example 8 | 0.1 | A | 0.1 | A | 0.1 | A | 0.06 | A | 96 | B |
| Example 9 | 0.1 | A | 0.1 | A | 0.1 | A | 0.06 | A | 99 | A |
| Example 10 | 0.2 | A | 0.1 | A | 0.2 | A | 0.11 | B | 99 | A |
| Example 11 | 0.2 | A | 0.1 | A | 0.2 | A | 0.11 | B | 99 | A |
| Example 12 | 0.2 | A | 0.1 | A | 0.2 | A | 0.11 | B | 99 | A |
| Example 13 | 0.1 | A | 0.1 | A | 0.1 | A | 0.05 | A | 99 | A |
| Example 14 | 0.1 | A | 0.1 | A | 0.1 | A | 0.07 | A | 99 | A |
| Example 15 | 0.1 | A | 0.1 | A | 0.1 | A | 0.09 | A | 99 | A |
| Example 16 | 0.1 | A | 0.1 | A | 0.1 | A | 0.07 | A | 98 | A |
| Example 17 | 0.1 | A | 0.1 | A | 0.1 | A | 0.09 | A | 96 | B |
| Example 18 | 0.1 | A | 0.1 | A | 0.1 | A | 0.08 | A | 99 | A |
| Example 19 | 0.1 | A | 0.1 | A | 0.1 | A | 0.09 | A | 99 | A |
| Example 20 | 0.1 | A | 0.1 | A | 0.1 | A | 0.09 | A | 96 | B |
| Example 21 | 0.1 | A | 0.1 | A | 0.1 | A | 0.09 | A | 99 | A |
| Example 22 | 0.2 | A | 0.1 | A | 0.2 | A | 0.12 | B | 99 | A |
| Example 23 | 0.3 | A | 0.1 | A | 0.2 | A | 0.12 | B | 97 | B |
| Example 24 | 0.2 | A | 0.4 | B | 0.5 | B | 0.12 | B | 99 | A |
| Example 25 | 0.3 | A | 0.1 | A | 0.2 | A | 0.12 | B | 97 | B |
| Comparative | 0.3 | A | 0.3 | A | 0.3 | A | 0.23 | C | 99 | A |
| Example 1 | | | | | | | | | | |
| Comparative | 0.1 | A | 0.1 | A | 0.1 | A | 0.25 | C | 93 | C |
| Example 2 | | | | | | | | | | |
| Comparative | 0.3 | A | 1.3 | D | 1.3 | D | 0.23 | C | 99 | A |
| Example 3 | | | | | | | | | | |
| Comparative | 0.1 | A | 0.1 | A | 0.1 | A | 0.25 | C | 93 | C |
| Example 4 | | | | | | | | | | |
| Comparative | 0.1 | A | 0.1 | A | 0.1 | A | 0.23 | C | 95 | B |
| Example 5 | | | | | | | | | | |
| Comparative | 0.1 | A | 0.1 | A | 0.1 | A | 0.20 | C | 96 | B |
| Example 6 | | | | | | | | | | |
| Comparative | 0.1 | A | 0.1 | A | 0.1 | A | 0.25 | C | 96 | B |
| Example 7 | | | | | | | | | | |
| Comparative | 0.3 | A | 0.3 | A | 0.3 | A | 0.28 | C | 99 | A |
| Example 8 | | | | | | | | | | |
| Comparative | 1.1 | C | 1.1 | C | 1.2 | C | 0.32 | D | 94 | C |
| Example 9 | | | | | | | | | | |
| Comparative | 1.2 | C | 0.1 | A | 0.3 | A | 0.30 | D | 89 | D |
| Example 10 | | | | | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-151473, filed Sep. 19, 2023 and Japanese Patent Application No. 2024-150913, filed Sep. 2, 2024 which are hereby incorporated by reference herein in their entirety.

What is claimed is:

1. A toner comprising a toner particle comprising a binder resin,
wherein the toner particle comprises a toner base particle and a silicon polymer composite present at a surface of the toner base particle,
the silicon polymer composite comprises
a silicon polymer and
at least one specific metal atom selected from the group consisting of metal atoms included in Groups 3 to 13, and
when, a ratio of the number of the specific metal atom to a sum of the numbers of a carbon atom, an oxygen atom, a silicon atom, a phosphorus atom, and the specific metal atom obtained by X-ray photoelectron spectroscopy on the toner is defined as ME, and a ratio of the number of the silicon atom to a sum of the numbers of a carbon atom, an oxygen atom, a silicon atom, a phosphorus atom, and the specific metal atom obtained by X-ray photoelectron spectroscopy on the toner is defined as SiE, and
in an EDS mapping image of constituent elements in a cross section of the toner obtained by analyzing with use of energy dispersive X-ray spectroscopy, the cross section of the toner observed with a transmission electron microscope, a ratio of the number of the specific metal atom to a sum of the numbers of a silicon atom and the specific metal atom in a region outside a contour of the toner base particle is defined as MX,
the ME, the SiE, and the MX satisfy Formulae (1) and (2) below:
$$0.5 \leq ( ME / Si E ) / MX \leq 2.5 ; and \qquad ( 1 )$$
$$5. \times {10}^{- 3} \leq MX \leq 6. \times {10}^{- 2} . \qquad ( 2 )$$

2. The toner according to claim 1, wherein the MX satisfies Formula (3) below:
$$1. \times {10}^{- 2} \leq MX \leq 6. \times {10}^{- 2} . \qquad ( 3 )$$

3. The toner according to claim 1, wherein the silicon polymer composite fixes on the surface of the toner base particle in a protrusion shape.

4. The toner according to claim 3, wherein
an image of the toner base particle and an image of the silicon polymer composite are observed in the EDS mapping image and the image of the silicon polymer composite is observed at a position corresponding to the surface of the toner base particle in the image of the toner base particle, and
when line scanning is performed in the EDS mapping image on a region X specified by a following method, a maximum value of a strength count of the specific metal atom is defined as Mmax, and an average value of the strength counts is defined as Mave, the Mmax and the Mave satisfy formula (4) below:
$$1. < M max / Mave < 1.8 ; \qquad ( 4 )$$
Method for Specifying the Region X:
(i) End points of an interface formed by the image of the silicon polymer composite and the image of the toner base particle are connected by a straight line to define a base line,
(ii) A perpendicular line L1 having a maximum length among perpendicular lines connecting the base line and an outer surface of the image of the silicon polymer composite is defined,
(iii) When a width of the image of the silicon polymer composite, which is a length of the base line, is defined as W, a line segment L2 connecting two points on an inner side of 0.1 W from respective end portions of the base line is defined on the base line,
(iv) A region in which a line segment overlaps the image of the silicon polymer composite when the line segment L2 is moved to a position of a midpoint of the perpendicular line L1 in parallel with the base line in a direction in which the perpendicular line L1 extends is defined as “region X”.

5. The toner according to claim 1, wherein a conductivity of the silicon polymer composite measured at a frequency of 10 kHz is 1.0×10⁻⁵ to 1.0×10⁻² S/m.

6. The toner according to claim 1, wherein in the silicon polymer composite, at least parts of the specific metal atoms and at least parts of silicon atoms are bonded via an oxygen atom.

7. The toner according to claim 1, wherein the specific metal atom comprises at least one metal atom selected from the group consisting of titanium, zirconium, copper, and aluminum.

8. The toner according to claim 1, wherein the specific metal atom comprises titanium.

9. The toner according to claim 1, wherein the silicon polymer composite comprises a polyhydric acid metal salt comprising a metal atom and a polyhydric acid.

10. The toner according to claim 1, wherein
the toner base particle comprises a condensation product of an organosilicon compound,
a normalized strength of silicon ions (m/z=28) derived from the condensation product and represented by Formula (I) below, in time-of-flight secondary ion mass spectrometry TOF-SIMS of the toner base particle is 7.00×10⁻⁴ to 3.00×10⁻², Normalized strength of silicon ions (m/z=28)={Ionic strength of silicon ions (m/z=28)}/{Total ionic strength at m/z=0.5 to 1850} (I), and
the normalized strength of the silicon ions (m/z=28) in the time-of-flight secondary ion mass spectrometry of the toner base particle sputtered by an Ar gas cluster ion beam Ar-GCIB under Conditions (A) below is 6.99×10⁻⁴ or less,
Conditions (A):
Acceleration voltage: 5 kV, current: 6.5 nA, raster size: 600×600 μm, irradiation time: 5 sec/cycle, and sputtering time: 250 sec.
